(19) United States
(12) Patent Application Publication
(10) Pub. No.: US 2023/0316405 A1
(43) Pub. Date: Oct. 5, 2023

(54) SYSTEMS AND METHODS FOR PROVIDING VEHICLE INSURANCE DISCOUNTS BASED ON USER RESPONSES TO QUESTIONNAIRES

(71) Applicant: BlueOwl, LLC, San Francisco, CA (US)

(72) Inventors: Kenneth Jason Sanchez, San Francisco, CA (US); Blake Konrardy, Chicago, IL (US)

(21) Appl. No.: 17/695,575

(22) Filed: Mar. 15, 2022

Related U.S. Application Data
(60) Provisional application No. 63/164,283, filed on Mar. 22, 2021.

(51) Int. Cl. G06Q 40/08; G06Q 30/02

(52) U.S. Cl. CPC G06Q 40/08; G06Q 30/0236

(57) ABSTRACT

Method and system for providing vehicle insurance discounts. For example, the method includes presenting questions to a user, receiving first responses to the questions, determining a first discount value for an insurance policy of a vehicle based upon the first responses, presenting the first discount value, receiving second responses to the questions, determining a second discount value based upon the second responses, determining an initial discount value based at least in part upon the first discount value and the second discount value, applying the initial discount value to the insurance policy for a predetermined period of time, collecting driving data associated with trips made by the vehicle during the predetermined period of time, analyzing the driving data to determine a third discount value, and after the predetermined period of time, replacing the initial discount value with the third discount value and applying the third discount value to the insurance policy.

### CROSS-REFERENCE TO RELATED APPLICATIONS

This application claims priority to U.S. Provisional Patent Application No. 63/164,283, filed Mar. 22, 2021, which is incorporated by reference herein for all purposes.

The following four applications, including this one, are being filed concurrently and the other three are hereby incorporated by reference in their entirety for all purposes:
1. U.S. patent application Ser. No. ______, titled “Systems and Methods for Providing Vehicle Insurance Discounts Based on User Responses to Questionnaires” (Attorney Docket Number BOL-00014C-NP1);
2. U.S. patent application Ser. No. ______, titled “Systems and Methods for Providing Vehicle Insurance Discounts Based on User Selection of Discount Values” (Attorney Docket Number BOL-00014D-NP1);
3. U.S. patent application Ser. No. ______, titled “Systems and Methods for Providing Vehicle Insurance Discounts Based on User Driving Behaviors” (Attorney Docket Number BOL-00014E-NP1); and
4. U.S. patent application Ser. No. ______, titled “Systems and Methods for Providing Vehicle Insurance Discounts Based on Responses from a User” (Attorney Docket Number BOL-00015-NP1).

### FIELD OF THE DISCLOSURE

Some embodiments of the present disclosure are directed to providing vehicle insurance discounts. More particularly, certain embodiments of the present disclosure provide methods and systems for determining vehicle insurance policies based in part upon a user's responses to questionnaires. Merely by way of example, the present disclosure has been applied to analyzing the user's responses to determine appropriate discount values for the vehicle insurance policies. But it would be recognized that the present disclosure has much broader range of applicability.

### BACKGROUND OF THE DISCLOSURE

Conventional vehicle insurance policies are based on a combination of rating factors for a driver (e.g., age, gender, location, driving history, annual mileage, etc.). However, these policies suffer from various drawbacks such as a failure to properly identify risks associated with the driver, lack of incentivizing preferred types of driving behaviors, inefficient customer communications, and/or other drawbacks. Hence, it is desirable to develop other methods that can better determine vehicle insurance policies.

### BRIEF SUMMARY OF THE DISCLOSURE

Some embodiments of the present disclosure are directed to providing vehicle insurance discounts. More particularly, certain embodiments of the present disclosure provide methods and systems for determining vehicle insurance policies based in part upon a user's responses to questionnaires. Merely by way of example, the present disclosure has been applied to analyzing the user's responses to determine appropriate discount values for the vehicle insurance policies. But it would be recognized that the present disclosure has much broader range of applicability.

According to certain embodiments, a method for providing vehicle insurance discounts includes presenting one or more questions to a user and receiving one or more first responses from the user to the one or more questions. Also, the method includes determining a first discount value for an insurance policy of a vehicle based at least in part upon the one or more first responses and presenting the first discount value for the insurance policy of the vehicle. Additionally, the method includes receiving one or more second responses from the user to the one or more questions and determining a second discount value for the insurance policy of the vehicle based at least in part upon the one or more second responses. Further, the method includes determining an initial discount value based at least in part upon the first discount value and the second discount value and applying the initial discount value to the insurance policy of the vehicle for a predetermined period of time. Moreover, the method includes collecting driving data associated with one or more trips made by the vehicle during the predetermined period of time and analyzing the driving data to determine a third discount value for the insurance policy of the vehicle. After the predetermined period of time, the method includes replacing the initial discount value with the third discount value and applying the third discount value to the insurance policy of the vehicle.

According to some embodiments, a computing device for providing vehicle insurance discounts includes one or more processors and a memory storing instructions for execution by the one or more processors. The instructions, when executed, cause the one or more processors to present one or more questions to a user and receive one or more first responses from the user to the one or more questions. Also, the instructions, when executed, cause the one or more processors to determine a first discount value for an insurance policy of a vehicle based at least in part upon the one or more first responses and present the first discount value for the insurance policy of the vehicle. Additionally, the instructions, when executed, cause the one or more processors to receive one or more second responses from the user to the one or more questions and determine a second discount value for the insurance policy of the vehicle based at least in part upon the one or more second responses. Further, the instructions, when executed, cause the one or more processors to determine an initial discount value based at least in part upon the first discount value and the second discount value and apply the initial discount value to the insurance policy of the vehicle for a predetermined period of time. Moreover, the instructions, when executed, cause the one or more processors to collect driving data associated with one or more trips made by the vehicle during the predetermined period of time and analyze the driving data to determine a third discount value for the insurance policy of the vehicle. After the predetermined period of time, the instructions, when executed, cause the one or more processors to replace the initial discount value with the third discount value and apply the third discount value to the insurance policy of the vehicle.

According to certain embodiments, a non-transitory computer-readable medium stores instructions for providing vehicle insurance discounts. The instructions are executed by one or more processors of a computing device. The non-transitory computer-readable medium includes instructions to present one or more questions to a user and receive one or more first responses from the user to the one or more questions. Also, the non-transitory computer-readable medium includes instructions to determine a first discount value for an insurance policy of a vehicle based at least in part upon the one or more first responses and present the first discount value for the insurance policy of the vehicle. Additionally, the non-transitory computer-readable medium includes instructions to receive one or more second responses from the user to the one or more questions and determine a second discount value for the insurance policy of the vehicle based at least in part upon the one or more second responses. Further, the non-transitory computer-readable medium includes instructions to determine an initial discount value based at least in part upon the first discount value and the second discount value and apply the initial discount value to the insurance policy of the vehicle for a predetermined period of time. Moreover, the non-transitory computer-readable medium includes instructions to collect driving data associated with one or more trips made by the vehicle during the predetermined period of time and analyze the driving data to determine a third discount value for the insurance policy of the vehicle. After the predetermined period of time, the non-transitory computer-readable medium includes instructions to replace the initial discount value with the third discount value and apply the third discount value to the insurance policy of the vehicle.

Depending upon the embodiment, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

FIG. 1A and FIG. 1B show a simplified method for providing vehicle insurance discounts based on user responses to questionnaires according to certain embodiments of the present disclosure.

FIG. 2A and FIG. 2B show a simplified method for providing vehicle insurance discounts based on user responses to questionnaires according to some embodiments of the present disclosure.

FIG. 3 shows a simplified system for providing vehicle insurance discounts based on user responses to questionnaires according to certain embodiments of the present disclosure.

FIG. 4 shows a simplified computing device for providing vehicle insurance discounts based on user responses to questionnaires according to certain embodiments of the present disclosure.

### DETAILED DESCRIPTION OF THE DISCLOSURE

Some embodiments of the present disclosure are directed to providing vehicle insurance discounts. More particularly, certain embodiments of the present disclosure provide methods and systems for determining vehicle insurance policies based in part upon a user's responses to questionnaires. Merely by way of example, the present disclosure has been applied to analyzing the user's responses to determine appropriate discount values for the vehicle insurance policies. But it would be recognized that the present disclosure has much broader range of applicability.

### I. ONE OR MORE METHODS FOR PROVIDING VEHICLE INSURANCE DISCOUNTS BASED ON USER RESPONSES TO QUESTIONNAIRES ACCORDING TO CERTAIN EMBODIMENTS

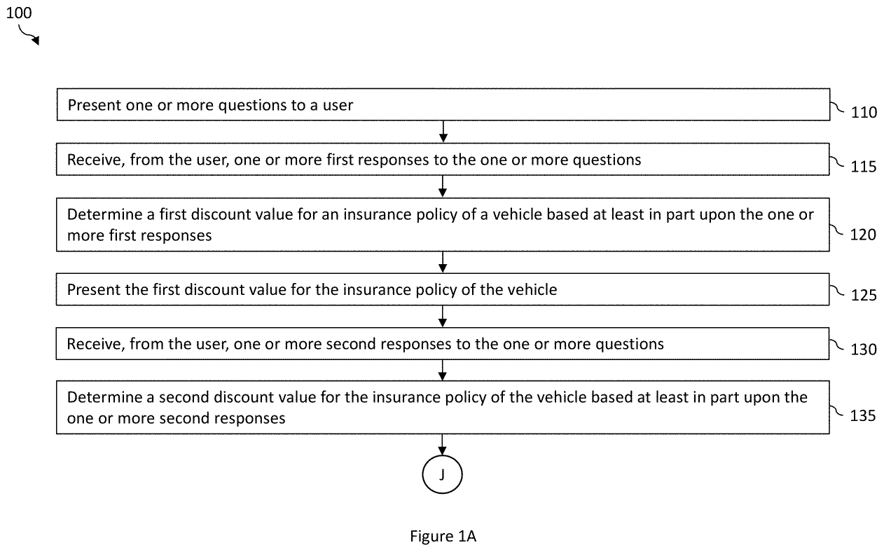

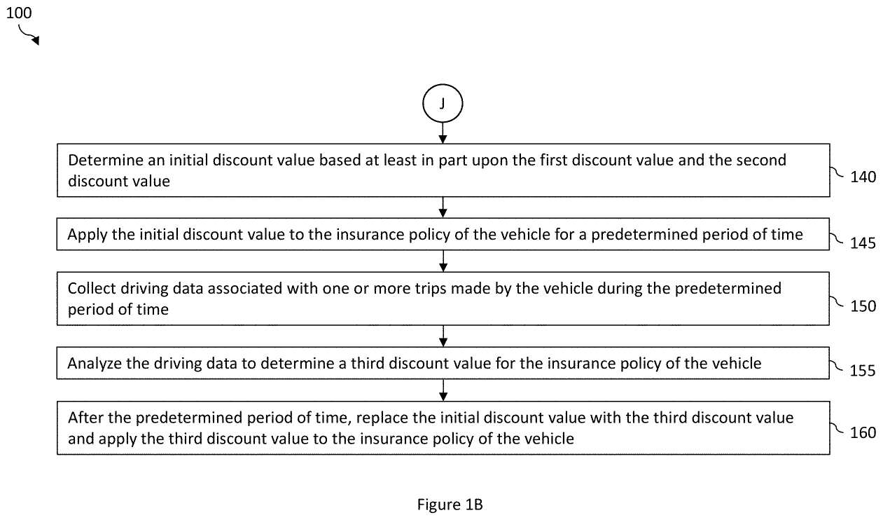

FIG. 1A and FIG. 1B show a simplified method for providing vehicle insurance discounts based on user responses to questionnaires according to certain embodiments of the present disclosure. The figures are merely examples, which should not unduly limit the scope of the claims. One of ordinary skill in the art would recognize many variations, alternatives, and modifications. The method 100 includes process 110 for presenting questions to a user, process 115 for receiving first responses from the user, process 120 for determining a first discount value, process 125 for presenting the first discount value, process 130 for receiving second responses from the user, process 135 for determining a second discount value, process 140 for determining an initial discount value, process 145 for applying the initial discount value, process 150 for collecting driving data, process 155 for analyzing the driving data to determine a third discount value, and process 160 for applying the third discount value. Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others replaced. For example, some or all processes of the method are performed by a computing device or a processor directed by instructions stored in memory. As an example, some or all processes of the method are performed according to instructions stored in a non-transitory computer-readable medium.

At the process 110, one or more questions are presented to the user according to certain embodiments. In various embodiments, the one or more questions are presented in the form of a questionnaire or survey. In some embodiments, the one or more questions are related to the user's driving behavior and/or driving style. For example, the one or more questions may ask how often the user drives, how many miles the user drives per day/week/month/year, if the user makes long or short distance trips, if the user has any tendency to drive at excessive speeds, if the user has any tendency to drive continuously without taking a break, if the user has any tendency to accelerate/decelerate rapidly, how other individuals may describe the user's driving, etc. At the process 115, one or more first responses are received from the user to the one or more questions according to certain embodiments. For example, the user provides an answer to each of the one or more questions.

At the process 120, the first discount value is determined for an insurance policy of a vehicle based at least in part upon the one or more first responses according to certain embodiments. In various embodiments, the one or more first responses are analyzed to determine the first discount value. In some embodiments, the first discount value is a percentage value. For example, if analysis of the one or more first responses indicates that the user does not drive often and has a cautious driving style, then a high percentage value may be determined for the first discount value. As an example, if analysis of the one or more first responses indicates that the user drives often and has a more adventurous driving style, then a low percentage value may be determined for the first discount value.

At the process 125, the first discount value for the insurance policy of the vehicle is presented according to certain embodiments. For example, the first discount value is displayed to the user (e.g., on the user's phone, laptop, desktop, etc.).

At the process 130, one or more second responses are received from the user to the one or more questions according to certain embodiments. For example, after the first discount value is presented, the user may decide to change his/her answers to the one or more questions in order to obtain a different discount value from the first discount value.

At the process 135, the second discount value is determined for the insurance policy of the vehicle based at least in part upon the one or more second responses according to certain embodiments. At the process 140, the initial discount value is determined based at least in part upon the first discount value and the second discount value according to certain embodiments. In some embodiments, if the first discount value and the second discount value are not equal, then the initial discount value is equal to greater of the first discount value and the second discount value. For example, if the first discount value is greater than the second discount value, then the initial discount value is equal to first discount value. As an example, if the second discount value is greater than the first discount value, then the initial discount value is equal to the second discount value. In certain embodiments, if the first discount value and the second discount value are equal, then the initial discount value is equal to the first discount value. In some embodiments, if the first discount value and the second discount value are equal, then the initial discount value is equal to the second discount value.

At the process 145, the initial discount value is applied to the insurance policy of the vehicle for a predetermined period of time according to certain embodiments. In some embodiments, the predetermined period of time may be one month in duration. For example, a premium or cost associated with the first month of the insurance policy is reduced by an amount equal to the initial discount value.

At the process 150, the driving data associated with one or more trips made by the vehicle during the predetermined period of time are collected according to certain embodiments. In some embodiments, the one or more trips are made for any suitable personal and/or business reasons (e.g., city travels, road trips, business trips, commuting to/from work, running errands, etc.). In certain embodiments, the driving data (e.g., telematics data) include information related to a driving behavior of the user during the predetermined period of time. For example, the driving data indicate how frequently the user drives, type of maneuvers that the user makes while driving, types of road that the user drives on, number of reported accidents/collisions, types of dangerous driving events, types of safe driving events, etc. In various embodiments, the driving data are collected from one or more sensors (e.g., accelerometers, gyroscopes, magnetometers, barometers, GPS sensors, cameras, etc.) located in the vehicle and/or in a computing device (e.g., a mobile device) associated with the vehicle during the one or more trips.

At the process 155, the driving data are analyzed to determine the third discount value for the insurance policy of the vehicle according to certain embodiments. In some embodiments, the third discount value is different from the initial discount value. For example, a high initial discount value may have been determined, but the user drove recklessly during the predetermined period of time. As an example, the initial discount value may not accurately reflect the actual discount that should be applied to the insurance policy. For example, the third discount value determined from the driving data is a more accurate indicator of the actual discount that should be applied to the insurance policy.

In certain embodiments, the third discount value is the same as the initial discount value. For example, a high initial discount value may have been determined, and the user drove carefully during the predetermined period of time. As an example, the initial discount value accurately reflects the actual discount applied to the insurance policy. For example, the third discount value determined from the driving data will be the same as the initial discount value to continue rewarding the user.

In some embodiments, a part of the driving data collected during a part of the predetermined period of time are analyzed to determine the driving behavior of the user during the part of the predetermined period of time. In certain embodiments, a fourth discount value is determined based at least in part upon the driving behavior of the user and compared to the initial discount value. For example, the fourth discount value is presented to indicate whether the driving behavior of the user is indicative of the initial discount value. In some examples, the various discount values are percentage values. In certain examples, the various discount values are fixed dollar amounts.

At the process 160, after the predetermined period of time, the initial discount value is replaced with the third discount value and the third discount value is applied to the insurance policy of the vehicle according to certain embodiments. For example, the third discount value is applied to the insurance policy of the vehicle for one or more subsequent months covered by the insurance policy. In some embodiments, after the predetermined period of time, one or more feedbacks (e.g., driving tips) are provided to the user based at least in part upon the driving data collected during the predetermined period of time. For example, the one or more feedbacks are provided to help correct and/or improve the user's driving behavior.

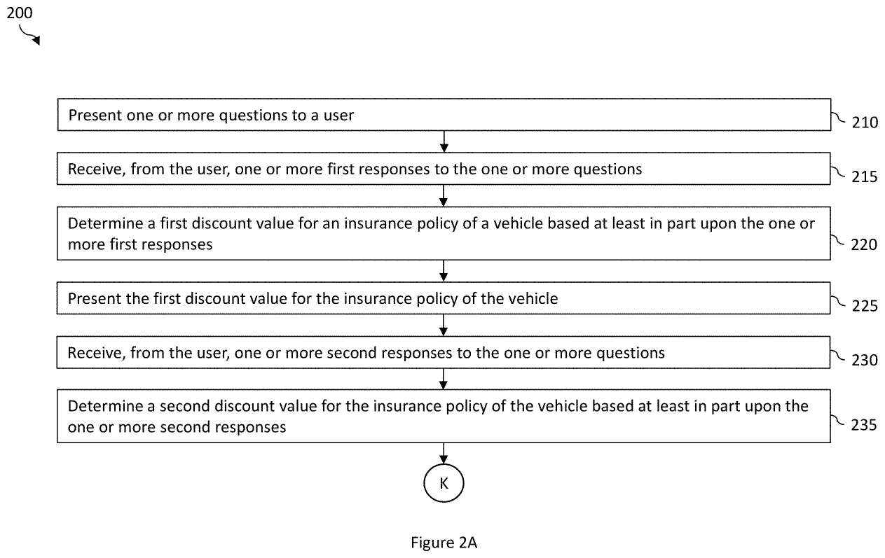

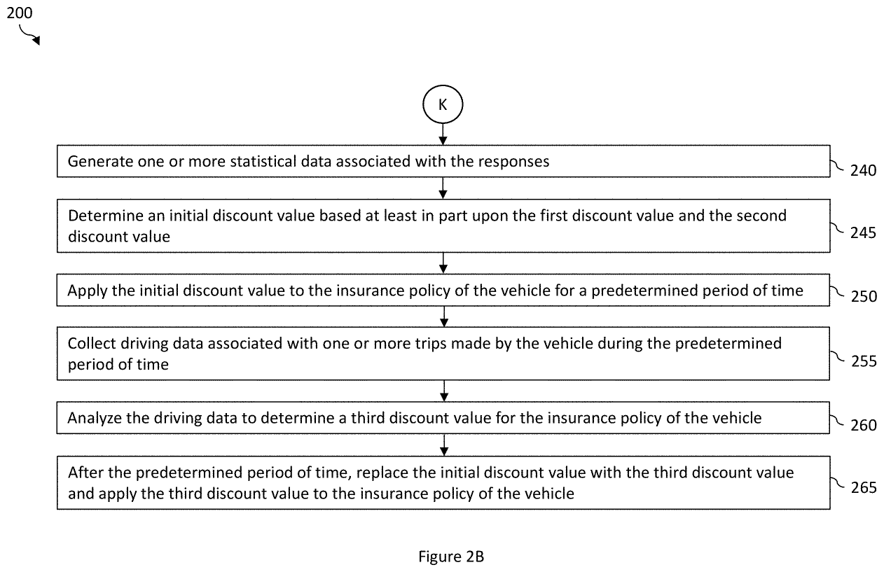

FIG. 2A and FIG. 2B show a simplified method for providing vehicle insurance discounts based on user responses to questionnaires according to some embodiments of the present disclosure. The figures are merely examples, which should not unduly limit the scope of the claims. One of ordinary skill in the art would recognize many variations, alternatives, and modifications. The method 200 includes process 210 for presenting questions to a user, process 215 for receiving first responses from the user, process 220 for determining a first discount value, process 225 for presenting the first discount value, process 230 for receiving second responses from the user, process 235 for determining a second discount value, process 240 for generating statistical data, process 245 for determining an initial discount value, process 250 for applying the initial discount value, process 255 for collecting driving data, process 260 for analyzing the driving data to determine a third discount value, and process 265 for applying the third discount value. Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others replaced. For example, some or all processes of the method are performed by a computing device or a processor directed by instructions stored in memory. As an example, some or all processes of the method are performed according to instructions stored in a non-transitory computer-readable medium.

At the process 210, one or more questions are presented to the user according to certain embodiments. In various embodiments, the one or more questions are presented in the form of a questionnaire or survey. In some embodiments, the one or more questions are related to the user's driving behavior and/or driving style. At the process 215, one or more first responses are received from the user to the one or more questions according to certain embodiments. For example, the user provides an answer to each of the one or more questions.

At the process 220, the first discount value is determined for an insurance policy of a vehicle based at least in part upon the one or more first responses according to certain embodiments. In various embodiments, the one or more first responses are analyzed to determine the first discount value. For example, if analysis of the one or more first responses indicates that the user does not drive often and has a cautious driving style, then a high value may be determined for the first discount value. As an example, if analysis of the one or more first responses indicates that the user drives often and has a more adventurous driving style, then a low value may be determined for the first discount value.

At the process 225, the first discount value for the insurance policy of the vehicle is presented according to certain embodiments. At the process 230, one or more second responses are received from the user to the one or more questions according to certain embodiments. At the process 235, the second discount value is determined for the insurance policy of the vehicle based at least in part upon the one or more second responses according to certain embodiments.

At the process 240, one or more statistical data associated with the responses are generated according to certain embodiments. In some embodiments, one or more first statistical data associated with the one or more first responses are generated. In certain embodiments, the one or more first statistical data indicate how the one or more first responses made by the user compare to one or more other responses made by one or more other users. For example, the one or more first statistical data may show whether the one or more first responses made by the user match the one or more other responses made by the one or more other users. In some embodiments, upon examining the one or more first statistical data, the user may decide to change his/her answers to the one or more questions.

In certain embodiments, one or more second statistical data associated with the one or more second responses are generated. In some embodiments, the one or more second statistical data indicate how the one or more second responses made by the user compare to the one or more other responses made by the one or more other users. For example, the one or more second statistical data may show whether the one or more second responses made by the user match the one or more other responses made by the one or more other users.

At the process 245, the initial discount value is determined based at least in part upon the first discount value and the second discount value according to certain embodiments. In some embodiments, if the first discount value and the second discount value are not equal, then the initial discount value is equal to greater of the first discount value and the second discount value. In certain embodiments, if the first discount value and the second discount value are equal, then the initial discount value is equal to the first discount value. In some embodiments, if the first discount value and the second discount value are equal, then the initial discount value is equal to the second discount value.

At the process 250, the initial discount value is applied to the insurance policy of the vehicle for a predetermined period of time according to certain embodiments. For example, the predetermined period of time may be one month in duration. As an example, a premium or cost associated with the first month of the insurance policy is reduced by an amount equal to the initial discount value.

At the process 255, the driving data associated with one or more trips made by the vehicle during the predetermined period of time are collected according to certain embodiments. In some embodiments, the driving data (e.g., telematics data) include information related to a driving behavior of the user during the predetermined period of time. In various embodiments, the driving data are collected from one or more sensors located in the vehicle and/or in a computing device (e.g., a mobile device) associated with the vehicle during the one or more trips.

At the process 260, the driving data are analyzed to determine the third discount value for the insurance policy of the vehicle according to certain embodiments. In some embodiments, the third discount value is different from the initial discount value. For example, a high initial discount value may have been determined, but the user drove recklessly during the predetermined period of time. As an example, the initial discount value may not accurately reflect the actual discount that should be applied to the insurance policy. For example, the third discount value determined from the driving data is a more accurate indicator of the actual discount that should be applied to the insurance policy. In certain embodiments, the third discount value is the same as the initial discount value. For example, a high initial discount value may have been determined, and the user drove carefully during the predetermined period of time. As an example, the initial discount value accurately reflects the actual discount applied to the insurance policy. For example, the third discount value determined from the driving data will be the same as the initial discount value to continue rewarding the user.

At the process 260, after the predetermined period of time, the initial discount value is replaced with the third discount value and the third discount value is applied to the insurance policy of the vehicle according to certain embodiments. For example, the third discount value is applied to the insurance policy of the vehicle for one or more subsequent months covered by the insurance policy.

### II. ONE OR MORE SYSTEMS FOR PROVIDING VEHICLE INSURANCE DISCOUNTS BASED ON USER RESPONSES TO QUESTIONNAIRES ACCORDING TO CERTAIN EMBODIMENTS

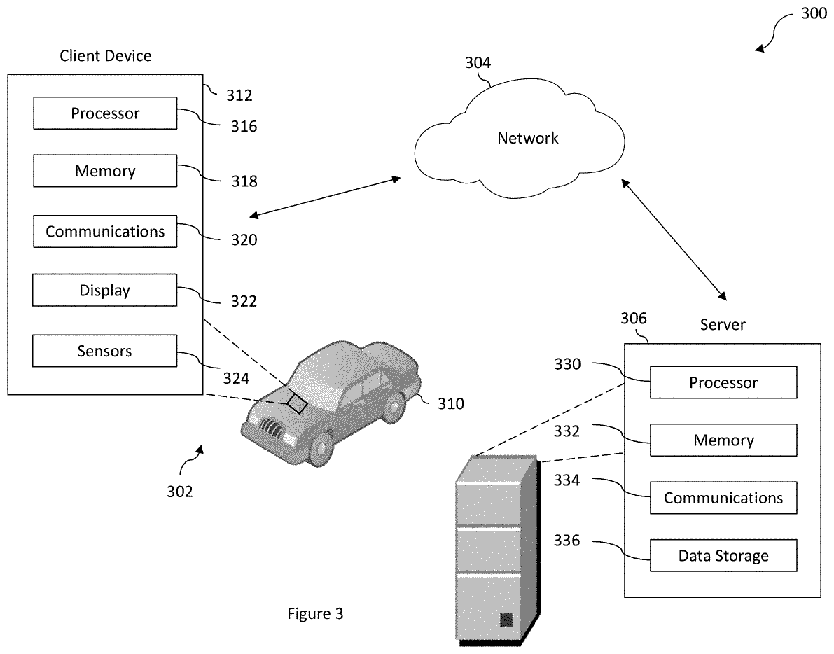

FIG. 3 shows a simplified system for providing vehicle insurance discounts based on user responses to questionnaires according to certain embodiments of the present disclosure. This figure is merely an example, which should not unduly limit the scope of the claims. One of ordinary skill in the art would recognize many variations, alternatives, and modifications. The system 300 includes a vehicle system 302, a network 304, and a server 306. Although the above has been shown using a selected group of components for the system, there can be many alternatives, modifications, and variations. For example, some of the components may be expanded and/or combined. Other components may be inserted to those noted above. Depending upon the embodiment, the arrangement of components may be interchanged with others replaced.

In various embodiments, the system 300 is used to implement the method 100 and/or the method 200. According to certain embodiments, the vehicle system 302 includes a vehicle 310 and a client device 312 associated with the vehicle 310. For example, the client device 312 is a mobile device (e.g., a smartphone) located in the vehicle 310. For example, the client device 312 includes a processor 316 (e.g., a central processing unit (CPU), a graphics processing unit (GPU)), a memory 318 (e.g., random-access memory (RAM), read-only memory (ROM), flash memory), a communications unit 320 (e.g., a network transceiver), a display unit 322 (e.g., a touchscreen), and one or more sensors 324 (e.g., an accelerometer, a gyroscope, a magnetometer, a barometer, a GPS sensor).

In some embodiments, the vehicle 310 is operated by a driver. In certain embodiments, multiple vehicles 310 exist in the system 300 which are operated by respective drivers. In various embodiments, during one or more vehicle trip segments, the one or more sensors 324 collect data associated with vehicle operation, such as acceleration, braking, location, etc. According to some embodiments, the data are collected continuously, at predetermined time intervals, and/or based on a triggering event (e.g., when each sensor has acquired a threshold amount of sensor measurements). In various embodiments, the collected data represent the telematics data and/or the device interaction data in the method 100 and/or the method 200.

According to certain embodiments, the collected data are stored in the memory 318 before being transmitted to the server 306 using the communications unit 320 via the network 304 (e.g., via a local area network (LAN), a wide area network (WAN), the Internet). In some embodiments, the collected data are transmitted directly to the server 306 via the network 304. For example, the collected data are transmitted to the server 306 without being stored in the memory 318. In certain embodiments, the collected data are transmitted to the server 306 via a third party. For example, a data monitoring system stores any and all data collected by the one or more sensors 324 and transmits those data to the server 306 via the network 304 or a different network.

According to some embodiments, the server 306 includes a processor 330 (e.g., a microprocessor, a microcontroller), a memory 332, a communications unit 334 (e.g., a network transceiver), and a data storage 336 (e.g., one or more databases). In some embodiments, the server 306 is a single server, while in certain embodiments, the server 306 includes a plurality of servers with distributed processing. In FIG. 3, the data storage 336 is shown to be part of the server 306. In certain embodiments, the data storage 336 is a separate entity coupled to the server 306 via a network such as the network 304. In some embodiments, the server 306 includes various software applications stored in the memory 332 and executable by the processor 330. For example, these software applications include specific programs, routines, or scripts for performing functions associated with the method 100 and/or the method 200. As an example, the software applications include general-purpose software applications for data processing, network communication, database management, web server operation, and/or other functions typically performed by a server.

According to various embodiments, the server 306 receives, via the network 304, the data collected by the one or more sensors 324 using the communications unit 334 and stores the data in the data storage 336. For example, the server 306 then processes the data to perform one or more processes of the method 100 and/or one or more processes of the method 200.

According to certain embodiments, any related information determined or generated by the method 100 and/or the method 200 (e.g., questions, responses, discount values, etc.) are transmitted back to the client device 312, via the network 304, to be provided (e.g., displayed) to the user via the display unit 322.

In some embodiments, one or more processes of the method 100 and/or one or more processes of the method 200 are performed by the client device 312. For example, the processor 316 of the client device 312 processes the data collected by the one or more sensors 324 to perform one or more processes of the method 100 and/or one or more processes of the method 200.

### III. ONE OR MORE COMPUTING DEVICES FOR PROVIDING VEHICLE INSURANCE DISCOUNTS BASED ON USER RESPONSES TO QUESTIONNAIRES ACCORDING TO CERTAIN EMBODIMENTS

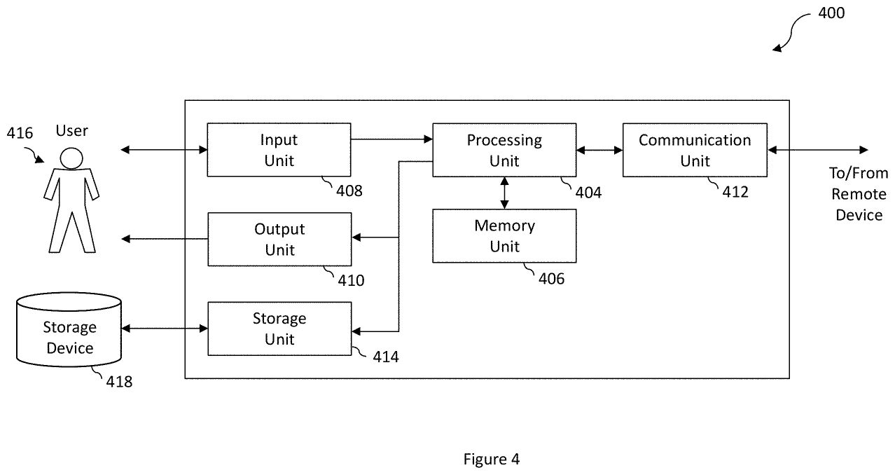

FIG. 4 shows a simplified computing device for providing vehicle insurance discounts based on user responses to questionnaires according to certain embodiments of the present disclosure. This figure is merely an example, which should not unduly limit the scope of the claims. One of ordinary skill in the art would recognize many variations, alternatives, and modifications. The computing device 400 includes a processing unit 404, a memory unit 406, an input unit 408, an output unit 410, a communication unit 412, and a storage unit 414. In various embodiments, the computing device 400 is configured to be in communication with a user 416 and/or a storage device 418. In certain embodiments, the computing device 400 includes the client device 312 and/or the server 306 of FIG. 3. In some embodiments, the computing device 400 is configured to implement the method 100 of FIG. 1A and/or FIG. 1B, and/or the method 200 of FIG. 2A and/or FIG. 2B. Although the above has been shown using a selected group of components for the system, there can be many alternatives, modifications, and variations. For example, some of the components may be expanded and/or combined. Other components may be inserted to those noted above. Depending upon the embodiment, the arrangement of components may be interchanged with others replaced.

In various embodiments, the processing unit 404 is configured for executing instructions, such as instructions to implement the method 100 of FIG. 1A and/or FIG. 1B, and/or the method 200 of FIG. 2A and/or FIG. 2B. In some embodiments, the executable instructions are stored in the memory unit 406. In certain embodiments, the processing unit 404 includes one or more processing units (e.g., in a multi-core configuration). In some embodiments, the processing unit 404 includes and/or is communicatively coupled to one or more modules for implementing the methods and systems described in the present disclosure. In certain embodiments, the processing unit 404 is configured to execute instructions within one or more operating systems. In some embodiments, upon initiation of a computer-implemented method, one or more instructions is executed during initialization. In certain embodiments, one or more operations is executed to perform one or more processes described herein. In some embodiments, an operation may be general or specific to a particular programming language (e.g., C, C++, Java, or other suitable programming languages, etc.).

In various embodiments, the memory unit 406 includes a device allowing information, such as executable instructions and/or other data to be stored and retrieved. In some embodiments, the memory unit 406 includes one or more computer readable media. In certain embodiments, the memory unit 406 includes computer readable instructions for providing a user interface, such as to the user 416, via the output unit 410. In some embodiments, a user interface includes a web browser and/or a client application. For example, a web browser enables the user 416 to interact with media and/or other information embedded on a web page and/or a website. In certain embodiments, the memory unit 406 includes computer readable instructions for receiving and processing an input via the input unit 408. In some embodiments, the memory unit 406 includes RAM such as dynamic RAM (DRAM) or static RAM (SRAM), ROM, erasable programmable read-only memory (EPROM), electrically erasable programmable read-only memory (EEPROM), and/or non-volatile RAM (NVRAM).

In various embodiments, the input unit 408 is configured to receive input (e.g., from the user 416). In some embodiments, the input unit 408 includes a keyboard, a pointing device, a mouse, a stylus, a touch sensitive panel (e.g., a touch pad or touch screen), a gyroscope, an accelerometer, a position sensor (e.g., GPS sensor), and/or an audio input device. In certain embodiments, the input unit 408 is configured to function as both an input unit and an output unit.

In various embodiments, the output unit 410 includes a media output unit configured to present information to the user 416. In some embodiments, the output unit 410 includes any component capable of conveying information to the user 416. In certain embodiments, the output unit 410 includes an output adapter such as a video adapter and/or an audio adapter. For example, the output unit 410 is operatively coupled to the processing unit 404 and/or a visual display device to present information to the user 416 (e.g., a liquid crystal display (LCD), a light emitting diode (LED) display, an organic light emitting diode (OLED) display, a cathode ray tube (CRT) display, a projected display, etc.). As an example, the output unit 410 is operatively coupled to the processing unit 404 and/or an audio display device to present information to the user 416 (e.g., a speaker arrangement or headphones).

In various embodiments, the communication unit 412 is configured to be communicatively coupled to a remote device. In some embodiments, the communication unit 412 includes a wired network adapter, a wireless network adapter, a wireless data transceiver for use with a mobile phone network (e.g., 3G, 4G, 5G, Bluetooth, near-field communication (NFC), etc.), and/or other mobile data networks. In certain embodiments, other types of short-range or long-range networks may be used. In some embodiments, the communication unit 412 is configured to provide email integration for communicating data between a server and one or more clients.

In various embodiments, the storage unit 414 is configured to enable communication between the computing device 400 and the storage device 418. In some embodiments, the storage unit 414 is a storage interface. For example, the storage interface is any component capable of providing the processing unit 404 with access to the storage device 418. In certain embodiments, the storage unit 414 includes an advanced technology attachment (ATA) adapter, a serial ATA (SATA) adapter, a small computer system interface (SCSI) adapter, a RAID controller, a SAN adapter, a network adapter, and/or any other component capable of providing the processing unit 404 with access to the storage device 418.

In various embodiments, the storage device 418 includes any computer-operated hardware suitable for storing and/or retrieving data. In certain embodiments, the storage device 418 is integrated in the computing device 400. In some embodiments, the storage device 418 includes a database such as a local database or a cloud database. In certain embodiments, the storage device 418 includes one or more hard disk drives. In some embodiments, the storage device 418 is external and is configured to be accessed by a plurality of server systems. In certain embodiments, the storage device 418 includes multiple storage units such as hard disks or solid state disks in a redundant array of inexpensive disks configuration. In some embodiments, the storage device 418 includes a storage area network and/or a network attached storage system.

### IV. EXAMPLES OF CERTAIN EMBODIMENTS OF THE PRESENT DISCLOSURE

According to certain embodiments, a method for providing vehicle insurance discounts includes presenting one or more questions to a user and receiving one or more first responses from the user to the one or more questions. Also, the method includes determining a first discount value for an insurance policy of a vehicle based at least in part upon the one or more first responses and presenting the first discount value for the insurance policy of the vehicle. Additionally, the method includes receiving one or more second responses from the user to the one or more questions and determining a second discount value for the insurance policy of the vehicle based at least in part upon the one or more second responses. Further, the method includes determining an initial discount value based at least in part upon the first discount value and the second discount value and applying the initial discount value to the insurance policy of the vehicle for a predetermined period of time. Moreover, the method includes collecting driving data associated with one or more trips made by the vehicle during the predetermined period of time and analyzing the driving data to determine a third discount value for the insurance policy of the vehicle. After the predetermined period of time, the method includes replacing the initial discount value with the third discount value and applying the third discount value to the insurance policy of the vehicle. For example, the method is implemented according to at least FIG. 1A, FIG. 1B, FIG. 2A and/or FIG. 2B.

According to some embodiments, a computing device for providing vehicle insurance discounts includes one or more processors and a memory storing instructions for execution by the one or more processors. The instructions, when executed, cause the one or more processors to present one or more questions to a user and receive one or more first responses from the user to the one or more questions. Also, the instructions, when executed, cause the one or more processors to determine a first discount value for an insurance policy of a vehicle based at least in part upon the one or more first responses and present the first discount value for the insurance policy of the vehicle. Additionally, the instructions, when executed, cause the one or more processors to receive one or more second responses from the user to the one or more questions and determine a second discount value for the insurance policy of the vehicle based at least in part upon the one or more second responses. Further, the instructions, when executed, cause the one or more processors to determine an initial discount value based at least in part upon the first discount value and the second discount value and apply the initial discount value to the insurance policy of the vehicle for a predetermined period of time. Moreover, the instructions, when executed, cause the one or more processors to collect driving data associated with one or more trips made by the vehicle during the predetermined period of time and analyze the driving data to determine a third discount value for the insurance policy of the vehicle. After the predetermined period of time, the instructions, when executed, cause the one or more processors to replace the initial discount value with the third discount value and apply the third discount value to the insurance policy of the vehicle. For example, the computing device is implemented according to at least FIG. 3 and/or FIG. 4.

According to certain embodiments, a non-transitory computer-readable medium stores instructions for providing vehicle insurance discounts. The instructions are executed by one or more processors of a computing device. The non-transitory computer-readable medium includes instructions to present one or more questions to a user and receive one or more first responses from the user to the one or more questions. Also, the non-transitory computer-readable medium includes instructions to determine a first discount value for an insurance policy of a vehicle based at least in part upon the one or more first responses and present the first discount value for the insurance policy of the vehicle. Additionally, the non-transitory computer-readable medium includes instructions to receive one or more second responses from the user to the one or more questions and determine a second discount value for the insurance policy of the vehicle based at least in part upon the one or more second responses. Further, the non-transitory computer-readable medium includes instructions to determine an initial discount value based at least in part upon the first discount value and the second discount value and apply the initial discount value to the insurance policy of the vehicle for a predetermined period of time. Moreover, the non-transitory computer-readable medium includes instructions to collect driving data associated with one or more trips made by the vehicle during the predetermined period of time and analyze the driving data to determine a third discount value for the insurance policy of the vehicle. After the predetermined period of time, the non-transitory computer-readable medium includes instructions to replace the initial discount value with the third discount value and apply the third discount value to the insurance policy of the vehicle. For example, the non-transitory computer-readable medium is implemented according to at least FIG. 1A, FIG. 1B, FIG. 2A, FIG. 2B, FIG. 3, and/or FIG. 4.

### V. ONE OR MORE SYSTEMS AND METHODS FOR PROVIDING VEHICLE INSURANCE DISCOUNTS ACCORDING TO SOME EMBODIMENTS

According to certain embodiments, a system and/or a method for presenting vehicle insurance discounts determined by a user includes determining discount values, receiving a discount value, presenting one or more statistical data associated with the discount value, collecting driving data during a predetermined period of time, presenting a driving behavior determined during the predetermined period of time, and/or providing one or more feedbacks after the predetermined period of time.

In some embodiments, a customized range of discount values for a user is determined. For example, the customized range of discount values is determined by analyzing user data associated with the user. As an example, the user data include the user's past telematics data, website interaction data, third party reports, etc. In certain embodiments, the customized range of discount values is a percentage range (e.g., 0% to 50%). In some embodiments, the customized range of discount values is a dollar amount range (e.g., $10 to $50).

In certain embodiments, the discount value is selected by the user from the customized range of discount values. In various embodiments, the discount value is manually selected by the user. For example, if the customized range of discount values shows a percentage range from 0% to 50%, then the user selects the discount value to be 40%.

In some embodiments, the one or more statistical data associated with the discount value are presented to the user. For example, the one or more statistical data indicate how the discount value selected by the user compares to one or more other discount values selected by one or more other users. As an example, if the user selected 50% as the discount value, then the one or more statistical data may indicate that a certain percentage of other users also selected 50% as their respective discount value.

In certain embodiments, the driving data associated with one or more trips made by a vehicle operated by the user during the predetermined period of time are collected. In various embodiments, the driving data include information related to the driving behavior of the user during the first predetermined period of time. For example, the driving data indicate how careful the user is in driving the vehicle, such as how frequently the user drives, type of maneuvers that the user makes while driving (e.g., hard cornering, hard braking, sudden acceleration, smooth acceleration, slowing before turning, etc.), types of road that the user drives on (e.g., highways, local roads, off-roads, etc.), number of reported accidents/collisions, types of dangerous driving events (e.g., cell phone usage while driving, eating while driving, falling asleep while driving, etc.), and/or types of safe driving events (e.g., maintaining safe following distance, turning on headlights, observing traffic lights, yielding to pedestrians, obeying speed limits, etc.).

In some embodiments, the driving data are collected from one or more sensors associated with the vehicle. For example, the one or more sensors include any type and number of accelerometers, gyroscopes, magnetometers, barometers, location sensors (e.g., GPS sensors), tilt sensors, yaw rate sensors, speedometers, brake sensors, airbag deployment sensors, headlight sensors, steering angle sensors, gear position sensors, proximity detectors, and/or any other suitable sensors that measure vehicle state and/or operation. In certain embodiments, the one or more sensors are part of or located in the vehicle. In some embodiments, the one or more sensors are part of a computing device (e.g., a mobile device of the user) that is connected to the vehicle while the vehicle is in operation. In certain embodiments, the driving data are collected continuously or at predetermined time intervals. In some embodiments, the driving data are collected based on a triggering event. For example, the driving data are collected when each sensor has acquired a threshold amount of sensor measurements.

In certain embodiments, the user is presented with whether the driving behavior of the user during the predetermined period of time is indicative of the discount value selected by the user. For example, the user is presented with a trend line that increases if the driving behavior correlates with the discount value (e.g., safe driving that warrants a high discount value), and decreases if the driving behavior does not correlate with the discount value (e.g., unsafe driving that does not warrant a high discount value).

In some embodiments, after the predetermined period of time, the user is presented with the one or more feedbacks based at least in part upon the driving data collected during the predetermined period of time. For example, the one or more feedbacks include various driving tips that can help to improve the user's driving behavior.

In certain embodiments, a method for presenting vehicle insurance discounts determined by a user includes determining a customized range of discount values for the user; receiving a discount value selected by the user from the customized range of discount values; presenting one or more statistical data associated with the discount value that indicate how the discount value selected by the user compares to one or more other discount values selected by one or more other users; collecting driving data associated with one or more trips made by a vehicle operated by the user during a predetermined period of time; presenting to the user whether a driving behavior of the user during the predetermined period of time is indicative of the discount value selected by the user; and/or after the predetermined period of time, providing one or more feedbacks to the user based at least in part upon the driving data collected during the predetermined period of time.

In some embodiments, a computing device for presenting vehicle insurance discounts determined by a user includes one or more processors and a memory that stores instructions for execution by the one or more processors. The instructions, when executed, cause the one or more processors to determine a customized range of discount values for the user; receive a discount value selected by the user from the customized range of discount values; present one or more statistical data associated with the discount value that indicate how the discount value selected by the user compares to one or more other discount values selected by one or more other users; collect driving data associated with one or more trips made by a vehicle operated by the user during a predetermined period of time; present to the user whether a driving behavior of the user during the predetermined period of time is indicative of the discount value selected by the user; and/or after the predetermined period of time, provide one or more feedbacks to the user based at least in part upon the driving data collected during the predetermined period of time.

In certain embodiments, a non-transitory computer-readable medium stores instructions for presenting vehicle insurance discounts determined by a user. The instructions are executed by one or more processors of a computing device. The non-transitory computer-readable medium includes instructions to determine a customized range of discount values for the user; receive a discount value selected by the user from the customized range of discount values; present one or more statistical data associated with the discount value that indicate how the discount value selected by the user compares to one or more other discount values selected by one or more other users; collect driving data associated with one or more trips made by a vehicle operated by the user during a predetermined period of time; present to the user whether a driving behavior of the user during the predetermined period of time is indicative of the discount value selected by the user; and/or after the predetermined period of time, provide one or more feedbacks to the user based at least in part upon the driving data collected during the predetermined period of time.

According to some embodiments, a system and/or a method for providing vehicle insurance discounts determined by a single user includes receiving a first discount value determined by a user, applying the first discount value for the user, collecting driving data of the user, analyzing the driving data to determine a second discount value, and/or applying the second discount value for the user.

In certain embodiments, the first discount value determined by the user for an insurance policy of a vehicle is received. For example, the first discount value is manually selected by the user. As an example, a customized range of discount values is presented to the user and the discount value is selected by the user from the customized range of discount values.

In some embodiments, the first discount value is applied to the insurance policy of the vehicle for a predetermined period of time. For example, the predetermined period of time may be one month in duration. As an example, a premium or cost associated with the first month of the insurance policy is reduced by an amount equal to the first discount value.

In certain embodiments, the driving data associated with one or more trips made by the vehicle made during the predetermined period of time are collected. In various embodiments, the driving data include information related to a driving behavior of the user during the predetermined period of time.

In some embodiments, the driving data are analyzed to determine the second discount value for the insurance policy of the vehicle. In certain embodiments, the second discount value is determined based at least in part upon on the driving behavior of the user during the predetermined period of time. In some embodiments, the second discount value is different from the first discount value.

In certain embodiments, after the predetermined period of time, the first discount value is replaced by the second discount value and the second discount value is applied to the insurance policy of the vehicle. For example, the second discount value is applied to the insurance policy of the vehicle for one or more subsequent months covered by the insurance policy.

According to some embodiments, a system and/or method for providing vehicle insurance discounts determined by multiple users includes receiving a first discount value determined by a first user, applying the first discount value for the first user, collecting first driving data of the first user, analyzing the first driving data to determine a second discount value, applying the second discount value for the first user, receiving a third discount value determined by a second user, applying the third discount value for the second user, collecting second driving data of the second user, analyzing the second driving data to determine a fourth discount value, and/or applying the fourth discount value for the second user.

In certain embodiments, the first discount value determined by the first user for a first insurance policy of a first vehicle is received. In various embodiments, the first discount value is manually selected by the first user. In some embodiments, a first customized range of discount values is presented to the first user and the first discount value is selected by the first user from the first customized range of discount values. For example, the first customized range of discount values is presented as a percentage range from 0% to 50%. As an example, the first user selects 40% as the first discount value from the percentage range.

In some embodiments, the first customized range of discount values is determined by receiving and analyzing first user data associated with the first user. For example, the first user data include the first user's past telematics data, website interaction data, third party reports, etc. In certain embodiments, analyzing the first user data includes processing the first user data and a default range of discount values. For example, the default range of discount values may be associated with certain user characteristics. In some embodiments, the first customized range of discount values is determined based at least in part upon the first user data and the default range of discount values.

In certain embodiments, the first customized range of discount values is different from the default range of discount values. For example, the default range of discount values may indicate a percentage range of 0% to 50%, and the first customized range of discount values may indicate a different range such as 0% to 40% or 10% to 50%. In some embodiments, the first customized range of discount values falls within the default range of discount values. For example, the default range of discount values may indicate a percentage range of 0% to 50%, and the first customized range of discount values may indicate a range of 10% to 20%. In certain embodiments, the first customized range of discount values is the same as the default range of discount values. For example, the default range of discount values may indicate a percentage range of 0% to 50%, and the first customized range of discount values may indicate the same range of 0% to 50%.

In some embodiments, one or more statistical data associated with the first discount value are generated to indicate how the first discount value determined by the first user compares to one or more other discount values determined by one or more other users. For example, if the first user selected 50% as the first discount value, then the one or more statistical data may indicate that a majority of other users (e.g., 80%) also selected 50% as their respective discount value.

In certain embodiments, the first discount value is applied to the first insurance policy of the first vehicle for a first predetermined period of time. For example, the first predetermined period of time may be one month in duration. As an example, a premium or cost associated with the first month of the first insurance policy is reduced by an amount equal to the first discount value.

In some embodiments, the first driving data associated with one or more first trips made by the first vehicle made during the first predetermined period of time are collected. In certain embodiments, the first driving data include information related to a first driving behavior of the first user during the first predetermined period of time. For example, the first driving data indicate how frequently the first user drives, type of maneuvers that the first user makes while driving, types of road that the first user drives on, number of reported accidents/collisions, types of dangerous driving events, and/or types of safe driving events. In some embodiments, the first driving data are collected from one or more sensors (e.g., accelerometers, gyroscopes, barometers, GPS sensors, etc.) associated with the first vehicle.

In certain, the first driving data are analyzed to determine the second discount value for the first insurance policy of the first vehicle. In various embodiments, the second discount value is determined based at least in part upon on the first driving behavior of the first user during the first predetermined period of time. In some embodiments, the second discount value is different from the first discount value. For example, the first user may have selected a high value for the first discount value but then drove recklessly during the first predetermined period of time. As an example, the first discount value may not accurately reflect the actual discount that should be applied to the first insurance policy. For example, the second discount value as determined from the first driving data may be a better indicator of the actual discount that should be applied. In certain embodiments, the second discount value is the same as the first discount value. For example, the first user may have selected a high value for the first discount value and drove carefully during the first predetermined period of time. As an example, the first discount value will accurately reflect the actual discount applied to the first insurance policy. For example, the second discount value as determined from the first driving data will be the same as the first discount value to continue rewarding the first user.

In some embodiments, a part of the first driving data collected during a part of the first predetermined period of time are analyzed to determine the first driving behavior of the first user during the part of the first predetermined period of time. In certain embodiments, a discount value determined based at least in part upon the first driving behavior of the first user may be compared to the first discount value. In some embodiments, the first user is presented with whether the first driving behavior of the first user is indicative of the first discount value determined by the first user. For example, the first user is presented with an increasing trend line if the first driving behavior correlates with the first discount value (e.g., safe driving that warrants a high first discount value). As an example, the first user is presented with a decreasing trend line if the first driving behavior does not correlate with the first discount value (e.g., unsafe driving that does not warrant a high first discount value).

In certain embodiments, after the first predetermined period of time, the first discount value is replaced by the second discount value and the second discount value is applied to the first insurance policy of the first vehicle. For example, the second discount value is applied to the first insurance policy of the first vehicle for one or more subsequent months covered by the first insurance policy. In some embodiments, after the first predetermined period of time, one or more first feedbacks are provided to the first user based at least in part upon the first driving data collected during the first predetermined period of time. For example, the one or more first feedbacks include various driving tips that can help to improve the first user's driving behavior.

In some embodiments, the third discount value determined by the second user for a second insurance policy of a second vehicle is received. In various embodiments, the first user and the second user are two different users. In certain embodiments, the first discount value determined by the first user is the same as the third discount value determined by the second user. For example, both the first and second users select the same discount percentage value. In some embodiments, the first discount value determined by the first user is different from the third discount value determined by the second user. For example, each of the first and second users selects a different discount percentage value.

In various embodiments, the third discount value is manually selected by the second user. In some embodiments, a second customized range of discount values is presented to the second user and the third discount value is selected by the second user from the second customized range of discount values. For example, the second customized range of discount values is presented as a percentage range from 5% to 60%. As an example, the second user selects 25% as the third discount value from the percentage range.

In certain embodiments, the second customized range of discount values is determined by receiving and analyzing second user data associated with the second user. For example, the second user data include the second user's past telematics data, website interaction data, third party reports, etc. In some embodiments, analyzing the second user data includes processing the second user data and the default range of discount values. In certain embodiments, the second customized range of discount values is determined based at least in part upon the second user data and the default range of discount values.

In some embodiments, the second customized range of discount values is the same as the first customized range of discount values. For example, the first user and the second user may share certain common attributes that allow the first user data and the second user data to be similar. As an example, both the first and second users are safe drivers that drive cautiously. In certain embodiments, the second customized range of discount values is different from the first customized range of discount values. For example, the first user and the second user behave differently such that the first user data and the second user data do not share any similarity. As example, the first user engages in safe driving while the second user engages in careless driving.

In certain embodiments, one or more statistical data associated with the third discount value are generated to indicate how the third discount value determined by the second user compares to the one or more other discount values determined by the one or more other users. For example, if the second user selected 10% as the third discount value, then the one or more statistical data may indicate that only a minority of other users (e.g., 20%) also selected 10% as their respective discount value.

In some embodiments, the third discount value is applied to the second insurance policy of the second vehicle for a second predetermined period of time. For example, the second predetermined period of time may be one month in duration. As an example, a premium or cost associated with the first month of the second insurance policy is reduced by an amount equal to the third discount value. In various embodiments, the second predetermined period of time and the first predetermined period of time are the same in duration.

In certain embodiments, the second driving data associated with one or more second trips made by the second vehicle made during the second predetermined period of time are collected. In some embodiments, the second driving data include information related to a second driving behavior of the second user during the second predetermined period of time. For example, the second driving data indicate how frequently the second user drives, type of maneuvers that the second user makes while driving, types of road that the second user drives on, number of reported accidents/collisions, types of dangerous driving events, and/or types of safe driving events. In certain embodiments, the second driving data are collected from one or more sensors (e.g., accelerometers, gyroscopes, barometers, GPS sensors, etc.) associated with the second vehicle.

In some embodiments, the second driving data are analyzed to determine the fourth discount value for the second insurance policy of the second vehicle. In various embodiments, the fourth discount value is determined based at least in part upon on the second driving behavior of the second user during the second predetermined period of time. In certain embodiments, the fourth discount value is different from the third discount value. In some embodiments, the fourth discount value is the same as the third discount value.

In certain embodiments, a part of the second driving data collected during a part of the second predetermined period of time are collected to determine the second driving behavior of the second user during the part of the second predetermined period of time. In some embodiments, a discount value determined based at least in part upon the second driving behavior of the second user may be compared to the third discount value. In certain embodiments, the second user is presented with whether the second driving behavior of the second user is indicative of the third discount value determined by the second user. As an example, the second user is presented with an increasing trend line if the second driving behavior warrants the third discount value. For example, the second user is presented with a decreasing trend line if the second driving behavior does not warrant the third discount value.

In some embodiments, after the second predetermined period of time, the third discount value is replaced by the fourth discount value and the fourth discount value is applied to the second insurance policy of the second vehicle. For example, the fourth discount value is applied to the second insurance policy of the second vehicle for one or more subsequent months covered by the second insurance policy. In certain embodiments, after the second predetermined period of time, one or more second feedbacks are provided to the second user based at least in part upon the second driving data collected during the second predetermined period of time. For example, the one or more second feedbacks include various driving tips that can help to improve the second user's driving behavior.

In certain embodiments, a method for providing vehicle insurance discounts determined by multiple users includes receiving a first discount value determined by a first user for a first insurance policy of a first vehicle; applying the first discount value to the first insurance policy of the first vehicle for a first predetermined period of time; collecting first driving data associated with one or more first trips made by the first vehicle during the first predetermined period of time; analyzing, the first driving data to determine a second discount value for the first insurance policy of the first vehicle; after the first predetermined period of time, replacing the first discount value with the second discount value and applying the second discount value to the first insurance policy of the first vehicle; receiving a third discount value determined by a second user for a second insurance policy of a second vehicle; applying the third discount value to the second insurance policy of the second vehicle for a second predetermined period of time; collecting second driving data associated with one or more second trips made by the second vehicle during the second predetermined period of time; analyzing the second driving data to determine a fourth discount value for the second insurance policy of the second vehicle; and/or after the second predetermined period of time, replacing the third discount value with the fourth discount value and applying the fourth discount value to the second insurance policy of the second vehicle.

In some embodiments, a computing device for providing vehicle insurance discounts determined by multiple users includes one or more processors and a memory that stores instructions for execution by the one or more processors. The instructions, when executed, cause the one or more processors to receive a first discount value determined by a first user for a first insurance policy of a first vehicle; apply the first discount value to the first insurance policy of the first vehicle for a first predetermined period of time; collect first driving data associated with one or more first trips made by the first vehicle during the first predetermined period of time; analyze the first driving data to determine a second discount value for the first insurance policy of the first vehicle; after the first predetermined period of time, replace the first discount value with the second discount value and apply the second discount value to the first insurance policy of the first vehicle; receive a third discount value determined by a second user for a second insurance policy of a second vehicle; apply the third discount value to the second insurance policy of the second vehicle for a second predetermined period of time; collect second driving data associated with one or more second trips made by the second vehicle during the second predetermined period of time; analyze the second driving data to determine a fourth discount value for the second insurance policy of the second vehicle; and/or after the second predetermined period of time, replace the third discount value with the fourth discount value and apply the fourth discount value to the second insurance policy of the second vehicle.

In certain embodiments, a non-transitory computer-readable medium stores instructions for providing vehicle insurance discounts determined by multiple users. The instructions are executed by one or more processors of a computing device. The non-transitory computer-readable medium includes instructions to receive a first discount value determined by a first user for a first insurance policy of a first vehicle; apply the first discount value to the first insurance policy of the first vehicle for a first predetermined period of time; collect first driving data associated with one or more first trips made by the first vehicle during the first predetermined period of time; analyze the first driving data to determine a second discount value for the first insurance policy of the first vehicle; after the first predetermined period of time, replace the first discount value with the second discount value and apply the second discount value to the first insurance policy of the first vehicle; receive a third discount value determined by a second user for a second insurance policy of a second vehicle; apply the third discount value to the second insurance policy of the second vehicle for a second predetermined period of time; collect second driving data associated with one or more second trips made by the second vehicle during the second predetermined period of time; analyze the second driving data to determine a fourth discount value for the second insurance policy of the second vehicle; and/or after the second predetermined period of time, replace the third discount value with the fourth discount value and apply the fourth discount value to the second insurance policy of the second vehicle.

According to some embodiments, a system and/or method for providing vehicle insurance discounts determined by one or more user responses to one or more questions includes presenting questions to a user, receiving first responses from the user, determining a first discount value, presenting the first discount value, receiving second responses from the user, determining a second discount value, applying the second discount value, collecting driving data, analyzing the driving data to determine a third discount value, and/or applying the third discount value.

In certain embodiments, one or more questions are presented to the user. In various embodiments, the one or more questions ask how often the user drives, how many miles are driven per week, if there are any tendency to drive at excessive speed, if there are any tendency to drive long distances without taking a break, how other individuals may describe the user's driving style, etc.

In some embodiments, one or more first responses from the user to the one or more questions are received. For example, the user provides answers to each of the one or more questions. In certain embodiments, the first discount value is determined for an insurance policy of a vehicle based at least in part upon the one or more first responses. In some embodiments, the one or more first responses are analyzed to determine the first discount value. For example, if the one or more first responses indicate that the user does not drive often and has a cautious driving style, then a high value may be determined for the first discount value. As an example, if the one or more first responses indicate that the user drives often and has a more adventurous driving style, then a low value may be determined for the first discount value.

In certain embodiments, the first discount value for the insurance policy of the vehicle is presented. In some embodiments, one or more first statistical data associated with the one or more first responses to the one or more questions are generated. For example, the one or more first statistical data indicate how the one or more first responses by the user compare to one or more other responses to the one or more questions by one or more other users.

In some embodiments, one or more second responses from the user to the one or more questions are received. For example, the user may decide to change his/her answers to the one or more questions upon examining the one or more first statistical data. In certain embodiments, one or more second statistical data associated with the one or more second responses to the one or more questions are generated. For example, the one or more second statistical data indicate how the one or more second responses by the user compare to the one or more other responses to the one or more questions by the one or more other users.

In certain embodiments, the second discount value is determined for the insurance policy of the vehicle based at least in part upon the one or more second responses. In some embodiments, the second discount value is applied to the insurance policy of the vehicle for a predetermined period of time. For example, the predetermined period of time may be one month in duration. As an example, a premium or cost associated with the first month of the insurance policy is reduced by an amount equal to the second discount value.

In some embodiments, the driving data associated with one or more trips made by the vehicle during the predetermined period of time are collected. In certain embodiments, the driving data include information related to a driving behavior of the user during the predetermined period of time. For example, the driving data indicate how frequently the user drives, type of maneuvers that the user makes while driving, types of road that the user drives on, number of reported accidents/collisions, types of dangerous driving events, and/or types of safe driving events. In some embodiments, the driving data are collected from one or more sensors (e.g., accelerometers, gyroscopes, barometers, GPS sensors, etc.) associated with the vehicle.

In certain embodiments, the driving data are analyzed to determine the third discount value for the insurance policy of the vehicle. In some embodiments, the third discount value is different from the second discount value. For example, a high value for the second discount value may have been determined from the one or more second responses by the user but the user drove recklessly during the predetermined period of time. As an example, the second discount value may not accurately reflect the actual discount that should be applied to the insurance policy. For example, the third discount value determined from the driving data may be a better indicator of the actual discount that should be applied. In some embodiments, the third discount value is the same as the second discount value. For example, a high value for the second discount value may have been determined from the one or more second responses by the user and the user drove carefully during the predetermined period of time. As an example, the second discount value will accurately reflect the actual discount applied to the insurance policy. For example, the third discount value determined from the driving data will be the same as the second discount value to continue rewarding the user.

In some embodiments, a part of the driving data collected during a part of the predetermined period of time are analyzed to determine the driving behavior of the user during the part of the predetermined period of time. In certain embodiments, a fourth discount value is determined based at least in part upon the driving behavior of the user and compared with the second discount value to indicate whether the driving behavior of the user is indicative of the second discount value.

In certain embodiments, after the predetermined period of time, the second discount value is replaced with the third discount value and the third discount value is applied to the insurance policy of the vehicle. For example, the third discount value is applied to the insurance policy of the vehicle for one or more subsequent months covered by the insurance policy. In some embodiments, after the predetermined period of time, one or more feedbacks (e.g., driving tips) are provided to the user based at least in part upon the driving data collected during the predetermined period of time.

In some embodiments, a method for providing vehicle insurance discounts determined by one or more user responses to one or more questions includes presenting the one or more questions to a user; receiving one or more first responses from the user to the one or more questions; determining a first discount value for an insurance policy of a vehicle based at least in part upon the one or more first responses; presenting the first discount value for the insurance policy of the vehicle; receiving one or more second responses from the user to the one or more questions; determining a second discount value for the insurance policy of the vehicle based at least in part upon the one or more second responses; applying the second discount value to the insurance policy of the vehicle for a predetermined period of time; collecting driving data associated with one or more trips made by the vehicle during the predetermined period of time; analyzing the driving data to determine a third discount value for the insurance policy of the vehicle; and/or after the predetermined period of time, replacing the second discount value with the third discount value and applying the third discount value to the insurance policy of the vehicle.

In certain embodiments, a computing device for providing vehicle insurance discounts determined by one or more user responses to one or more questions includes one or more processors and a memory that stores instructions for execution by the one or more processors. The instructions, when executed, cause the one or more processors to present the one or more questions to a user; receive one or more first responses from the user to the one or more questions; determine a first discount value for an insurance policy of a vehicle based at least in part upon the one or more first responses; present the first discount value for the insurance policy of the vehicle; receive one or more second responses from the user to the one or more questions; determine a second discount value for the insurance policy of the vehicle based at least in part upon the one or more second responses; apply the second discount value to the insurance policy of the vehicle for a predetermined period of time; collect driving data associated with one or more trips made by the vehicle during the predetermined period of time; analyze the driving data to determine a third discount value for the insurance policy of the vehicle; and/or after the predetermined period of time, replace the second discount value with the third discount value and apply the third discount value to the insurance policy of the vehicle.

In some embodiments, a non-transitory computer-readable medium stores instructions for providing vehicle insurance discounts determined one or more user responses to one or more questions. The instructions are executed by one or more processors of a computing device. The non-transitory computer-readable medium includes instructions to present the one or more questions to a user; receive one or more first responses from the user to the one or more questions; determine a first discount value for an insurance policy of a vehicle based at least in part upon the one or more first responses; present the first discount value for the insurance policy of the vehicle; receive one or more second responses from the user to the one or more questions; determine a second discount value for the insurance policy of the vehicle based at least in part upon the one or more second responses; apply the second discount value to the insurance policy of the vehicle for a predetermined period of time; collect driving data associated with one or more trips made by the vehicle during the predetermined period of time; analyze the driving data to determine a third discount value for the insurance policy of the vehicle; and/or after the predetermined period of time, replace the second discount value with the third discount value and apply the third discount value to the insurance policy of the vehicle.

According to certain embodiments, a system and/or method for generating statistical data related to vehicle insurance discounts determined by a user includes receiving a first discount value determined by a user, generating one or more statistical data associated with the first discount value, presenting the one or more statistical data associated with the first discount value, applying the first discount value, collecting driving data, analyzing the driving data to determine a second discount value, and/or applying the second discount value.

In some embodiments, the first discount value determined by the user for an insurance of a vehicle is received. For example, the first discount value is manually selected by the user. As an example, a customized range of discount values is presented to the user and the first discount value is selected by the user from the customized range of discount values.

In certain embodiments, the one or more statistical data associated with the first discount value determined by the user are generated. For example, the one or more statistical data indicate how the first discount value determined by the user compares to one or more other discount values determined by one or more other users. In some embodiments, the one or more statistical data associated with the first discount value determined by the user are presented. In certain embodiments, the first discount value is applied to the insurance policy of the vehicle for a predetermined period of time. For example, the predetermined period of time may be one month in duration. As an example, a premium or cost associated with the first month of the insurance policy is reduced by an amount equal to the first discount value.

In some embodiments, the driving data associated with one or more trips made by the vehicle during predetermined period of time are collected. In certain embodiments, the driving data include information related to a driving behavior of the user during the predetermined period of time. For example, the driving data indicate how frequently the user drives, type of maneuvers that the user makes while driving, types of road that the user drives on, number of reported accidents/collisions, types of dangerous driving events, and/or types of safe driving events. In some embodiments, the driving data are collected from one or more sensors (e.g., accelerometers, gyroscopes, barometers, GPS sensors, etc.) associated with the vehicle.

In certain embodiments, the driving data are analyzed to determine the second discount value for the insurance policy of the vehicle. In various embodiments, the second discount value is determined based at least in part upon on the driving behavior of the user during the predetermined period of time. In some embodiments, the second discount value is different from the first discount value. In certain embodiments, the second discount value is the same as the first discount value.

In some embodiments, after the predetermined period of time, the first discount value is replaced with the second discount value and the second discount value is applied to the insurance policy of the vehicle. For example, the second discount value is applied to the insurance policy of the vehicle for one or more subsequent months covered by the insurance policy.

In certain embodiments, a method for generating statistical data related to vehicle insurance discounts determined by a user includes receiving a first discount value determined by the user for an insurance policy of a vehicle; generating one or more statistical data associated with the first discount value that indicate how the first discount value determined by the user compares to one or more other discount values determined by one or more other users; presenting to the user the one or more statistical data associated with the first discount value determined by the user; applying the first discount value to the insurance policy of the vehicle for a predetermined period of time; collecting driving data associated with one or more trips made by the vehicle during the predetermined period of time; analyzing the driving data to determine a second discount value for the insurance policy of the vehicle; and/or after the predetermined period of time, replacing the first discount value with the second discount value and applying the second discount value to the insurance policy of the vehicle.

In some embodiments, a computing device for generating statistical data related to vehicle insurance discounts determined by a user includes one or more processors and a memory that stores instructions for execution by the one or more processors. The instructions, when executed, cause the one or more processors to receive a first discount value determined by the user for an insurance policy of a vehicle; generate one or more statistical data associated with the first discount value that indicate how the first discount value determined by the user compares to one or more other discount values determined by one or more other users; present to the user the one or more statistical data associated with the first discount value determined by the user; apply the first discount value to the insurance policy of the vehicle for a predetermined period of time; collect driving data associated with one or more trips made by the vehicle during the predetermined period of time; analyze the driving data to determine a second discount value for the insurance policy of the vehicle; and/or after the predetermined period of time, replace the first discount value with the second discount value and apply the second discount value to the insurance policy of the vehicle.

In certain embodiments, a non-transitory computer-readable medium stores instructions for generating statistical data related to vehicle insurance discounts determined by a user. The instructions are executed by one or more processors of a computing device. The non-transitory computer-readable medium includes instructions to receive a first discount value determined by the user for an insurance policy of a vehicle; generate one or more statistical data associated with the first discount value that indicate how the first discount value determined by the user compares to one or more other discount values determined by one or more other users; present to the user the one or more statistical data associated with the first discount value determined by the user; apply the first discount value to the insurance policy of the vehicle for a predetermined period of time; collect driving data associated with one or more trips made by the vehicle during the predetermined period of time; analyze the driving data to determine a second discount value for the insurance policy of the vehicle; and/or after the predetermined period of time, replace the first discount value with the second discount value and apply the second discount value to the insurance policy of the vehicle.

According to some embodiments, a system and/or method for indicating user driving behavior in view of vehicle insurance discounts determined by a user includes receiving a first discount value determined by a user, applying the first discount value, collecting driving data, determining a driving behavior by analyzing the driving data, presenting the driving behavior, analyzing the driving data to determine a second discount value, and/or applying the second discount value.

In certain embodiments, the first discount value determined by the user for an insurance of a vehicle is received. For example, the first discount value is manually selected by the user. As an example, a customized range of discount values is presented to the user and the first discount value is selected by the user from the customized range of discount values.

In some embodiments, the first discount value is applied to the insurance policy of the vehicle for a predetermined period of time. For example, the predetermined period of time may be one month in duration. As an example, a premium or cost associated with the first month of the insurance policy is reduced by an amount equal to the first discount value.

In certain embodiments, the driving data associated with one or more trips made by the vehicle during predetermined period of time are collected. For example, the driving data indicate how frequently the user drives, type of maneuvers that the user makes while driving, types of road that the user drives on, number of reported accidents/collisions, types of dangerous driving events, and/or types of safe driving events. In various embodiments, the driving data are collected from one or more sensors (e.g., accelerometers, gyroscopes, barometers, GPS sensors, etc.) associated with the vehicle.

In some embodiments, the driving behavior of the user is determined based at least in part upon analyzing the driving data collected during the predetermined period of time. In certain embodiments, the user is presented with whether the driving behavior of the user is indicative of the first discount value determined by the user. For example, the user is presented with an increasing trend line if the driving behavior of the user correlates with the first discount value. As an example, the user is presented with a decreasing trend line if the driving behavior of the user does not correlate with the first discount value.

In certain embodiments, the driving data are analyzed to determine the second discount value for the insurance policy of the vehicle. In various embodiments, the second discount value is determined based at least in part upon on the driving behavior of the user during the predetermined period of time. In some embodiments, the second discount value is different from the first discount value. In certain embodiments, the second discount value is the same as the first discount value.

In some embodiments, after the predetermined period of time, the first discount value is replaced with the second discount value and the second discount value is applied to the insurance policy of the vehicle. For example, the second discount value is applied to the insurance policy of the vehicle for one or more subsequent months covered by the insurance policy.

In certain embodiments, a method for indicating user driving behavior in view of vehicle insurance discounts determined by a user includes receiving a first discount value determined by the user for an insurance policy of a vehicle; applying the first discount value to the insurance policy of the vehicle for a predetermined period of time; collecting driving data associated with one or more trips made by the vehicle during the predetermined period of time; determining a driving behavior of the user based at least in part upon analyzing the driving data collected during the predetermined period of time; presenting to the user whether the driving behavior of the user is indicative of the first discount value determined by the user; analyzing the driving data to determine a second discount value for the insurance policy of the vehicle; and/or after the predetermined period of time, replacing the first discount value with the second discount value and applying, by the computing device, the second discount value to the insurance policy of the vehicle.

In some embodiments, a computing device for indicating user driving behavior in view of vehicle insurance discounts determined by a user includes one or more processors and a memory that stores instructions for execution by the one or more processors. The instructions, when executed, cause the one or more processors to receive a first discount value determined by the user for an insurance policy of a vehicle; apply the first discount value to the insurance policy of the vehicle for a predetermined period of time; collect driving data associated with one or more trips made by the vehicle during the predetermined period of time; determine a driving behavior of the user based at least in part upon analyzing the driving data collected during the predetermined period of time; present to the user whether the driving behavior of the user is indicative of the first discount value determined by the user; analyze the driving data to determine a second discount value for the insurance policy of the vehicle; and/or after the predetermined period of time, replace the first discount value with the second discount value and apply the second discount value to the insurance policy of the vehicle.

In certain embodiments, a non-transitory computer-readable medium stores instructions for indicating user driving behavior in view of vehicle insurance discounts determined by a user. The instructions are executed by one or more processors of a computing device. The non-transitory computer-readable medium includes instructions to receive a first discount value determined by the user for an insurance policy of a vehicle; apply the first discount value to the insurance policy of the vehicle for a predetermined period of time; collect driving data associated with one or more trips made by the vehicle during the predetermined period of time; determine a driving behavior of the user based at least in part upon analyzing the driving data collected during the predetermined period of time; present to the user whether the driving behavior of the user is indicative of the first discount value determined by the user; analyze the driving data to determine a second discount value for the insurance policy of the vehicle; and/or after the predetermined period of time, replace the first discount value with the second discount value and apply the second discount value to the insurance policy of the vehicle.

According to some embodiments, a system and/or method for generating statistical data related to vehicle insurance discounts determined by one or more user responses to one or more questions includes presenting questions to a user, receiving first responses from the user, determining a first discount value, presenting the first discount value, receiving second responses from the user, determining a second discount value, generating one or more first statistical data associated with the first responses, presenting the one or more first statistical data, generating one or more second statistical data associated with the second responses, presenting the one or more second statistical data, applying the second discount value, collecting driving data, analyzing the driving data to determine a third discount value, and/or applying the third discount value.

In certain embodiments, one or more questions are presented to the user. In various embodiments, the one or more questions ask how often the user drives, how many miles are driven per week, if there are any tendency to drive at excessive speed, if there are any tendency to drive long distances without taking a break, how other individuals may describe the user's driving style, etc.

In some embodiments, one or more first responses from the user to the one or more questions are received. For example, the user provides initial answers to each of the one or more questions. In certain embodiments, the first discount value is determined for an insurance policy of a vehicle based at least in part upon the one or more first responses. In some embodiments, the one or more first responses are analyzed to determine the first discount value. For example, if the one or more first responses indicate that the user does not drive often and has a cautious driving style, then a high value may be determined for the first discount value. As an example, if the one or more first responses indicate that the user drives often and has a more adventurous driving style, then a low value may be determined for the first discount value.

In certain embodiments, the first discount value for the first insurance policy of the vehicle is presented. In some embodiments, one or more second responses from the user to the one or more questions are received. For example, the user may revise or change the initial answers to each of the one or more questions. In certain embodiments, the second discount value is determined for the insurance policy of the vehicle based at least in part upon the one or more second responses. In various embodiments, the one or more second responses are analyzed to determine the second discount value.

In some embodiments, the one or more first statistical data associated with the one or more first responses to the one or more questions are generated. For example, the one or more first statistical data indicate how the one or more first responses by the user compare to one or more other responses to the one or more questions by one or more other users. In various embodiments, the one or more first statistical data associated with the one or more first responses to the one or more questions are presented to the user.

In certain embodiments, the one or more second statistical data associated with the one or more second responses to the one or more questions are generated. For example, the one or more second statistical data indicate how the one or more second responses by the user compare to the one or more other responses to the one or more questions by the one or more other users. In various embodiments, the one or more second statistical data associated with the one or more second responses to the one or more questions are presented to the user.

In some embodiments, the second discount value is applied to the insurance policy of the vehicle for a predetermined period of time. For example, the predetermined period of time may be one month in duration. As an example, a premium or cost associated with the first month of the insurance policy is reduced by an amount equal to the second discount value.

In certain embodiments, the driving data associated with one or more trips made by the vehicle during the predetermined period of time are collected. In some embodiments, the driving data include information related to a driving behavior of the user during the predetermined period of time. For example, the driving data indicate how frequently the user drives, type of maneuvers that the user makes while driving, types of road that the user drives on, number of reported accidents/collisions, types of dangerous driving events, and/or types of safe driving events. In certain embodiments, the driving data are collected from one or more sensors (e.g., accelerometers, gyroscopes, barometers, GPS sensors, etc.) associated with the vehicle.

In some embodiments, the driving data are analyzed to determine the third discount value for the insurance policy of the vehicle. In certain embodiments, the third discount value is different from the second discount value. For example, a high value for the second discount value may have been determined from the one or more second responses by the user but the user drove recklessly during the predetermined period of time. As an example, the second discount value may not accurately reflect the actual discount that should be applied to the insurance policy. For example, the third discount value determined from the driving data may be a better indicator of the actual discount that should be applied. In some embodiments, the third discount value is the same as the second discount value. For example, a high value for the second discount value may have been determined from the one or more second responses by the user and the user drove carefully during the predetermined period of time. As an example, the second discount value will accurately reflect the actual discount applied to the insurance policy. For example, the third discount value determined from the driving data will be the same as the second discount value to continue rewarding the user.

In certain embodiments, after the predetermined period of time, the second discount value is replaced with the third discount value and the third discount value is applied to the insurance policy of the vehicle. For example, the third discount value is applied to the insurance policy of the vehicle for one or more subsequent months covered by the insurance policy.

In some embodiments, a method for generating statistical data related to vehicle insurance discounts determined by one or more user responses to one or more questions includes presenting the one or more questions to a user; receiving one or more first responses from the user to the one or more questions; determining a first discount value for an insurance policy of a vehicle based at least in part upon the one or more first responses; presenting the first discount value for the insurance policy of the vehicle; receiving one or more second responses from the user to the one or more questions; determining a second discount value for the insurance policy of the vehicle based at least in part upon the one or more second responses; generating one or more first statistical data associated with the one or more first responses to the one or more questions that indicate how the one or more first responses by the user compare to one or more other responses to the one or more questions by one or more other users; presenting to the user the one or more first statistical data associated with the one or more first responses to the one or more questions; generating one or more second statistical data associated with the one or more second responses to the one or more questions that indicate how the one or more second responses by the user compare to the one or more other responses to the one or more questions by the one or more other users; presenting to the user the one or more second statistical data associated with the one or more second responses to the one or more questions; applying the second discount value to the insurance policy of the vehicle for a predetermined period of time; collecting driving data associated with one or more trips made by the vehicle during the predetermined period of time; analyzing the driving data to determine a third discount value for the insurance policy of the vehicle; and/or after the predetermined period of time, replacing the second discount value with the third discount value and applying, by the computing device, the third discount value to the insurance policy of the vehicle.

In certain embodiments, a computing device for generating statistical data related to vehicle insurance discounts determined by one or more user responses to one or more questions includes one or more processors and a memory that stores instructions for execution by the one or more processors. The instructions, when executed, cause the one or more processors to present the one or more questions to a user; receive one or more first responses from the user to the one or more questions; determine a first discount value for an insurance policy of a vehicle based at least in part upon the one or more first responses; present the first discount value for the insurance policy of the vehicle; receive one or more second responses from the user to the one or more questions; determine a second discount value for the insurance policy of the vehicle based at least in part upon the one or more second responses; generate one or more first statistical data associated with the one or more first responses to the one or more questions that indicate how the one or more first responses by the user compare to one or more other responses to the one or more questions by one or more other users; present to the user the one or more first statistical data associated with the one or more first responses to the one or more questions; generate one or more second statistical data associated with the one or more second responses to the one or more questions that indicate how the one or more second responses by the user compare to the one or more other responses to the one or more questions by the one or more other users; present to the user the one or more second statistical data associated with the one or more second responses to the one or more questions; apply the second discount value to the insurance policy of the vehicle for a predetermined period of time; collect driving data associated with one or more trips made by the vehicle during the predetermined period of time; analyze the driving data to determine a third discount value for the insurance policy of the vehicle; and/or after the predetermined period of time, replace the second discount value with the third discount value and apply the third discount value to the insurance policy of the vehicle.

In some embodiments, a non-transitory computer-readable medium stores instructions for generating statistical data related to vehicle insurance discounts determined by one or more user responses to one or more questions. The instructions are executed by one or more processors of a computing device. The non-transitory computer-readable medium includes instructions to present the one or more questions to a user; receive one or more first responses from the user to the one or more questions; determine a first discount value for an insurance policy of a vehicle based at least in part upon the one or more first responses; present the first discount value for the insurance policy of the vehicle; receive one or more second responses from the user to the one or more questions; determine a second discount value for the insurance policy of the vehicle based at least in part upon the one or more second responses; generate one or more first statistical data associated with the one or more first responses to the one or more questions that indicate how the one or more first responses by the user compare to one or more other responses to the one or more questions by one or more other users; present to the user the one or more first statistical data associated with the one or more first responses to the one or more questions; generate one or more second statistical data associated with the one or more second responses to the one or more questions that indicate how the one or more second responses by the user compare to the one or more other responses to the one or more questions by the one or more other users; present to the user the one or more second statistical data associated with the one or more second responses to the one or more questions; apply the second discount value to the insurance policy of the vehicle for a predetermined period of time; collect driving data associated with one or more trips made by the vehicle during the predetermined period of time; analyze the driving data to determine a third discount value for the insurance policy of the vehicle; and/or after the predetermined period of time, replace the second discount value with the third discount value and apply the third discount value to the insurance policy of the vehicle.

According to certain embodiments, a system and/or method for indicating user driving behavior in view of vehicle insurance discounts determined by one or more user responses to one or more questions includes presenting questions to a user, receiving first responses from the user, determining a first discount value, presenting the first discount value, receiving second responses from the user, determining a second discount value, applying the second discount value, collecting driving data, determining a driving behavior by analyzing the driving data, presenting the driving behavior, analyzing the driving data to determine a third discount value, and/or applying the third discount value.

In some embodiments, one or more questions are presented to the user. In various embodiments, the one or more questions ask how often the user drives, how many miles are driven per week, if there are any tendency to drive at excessive speed, if there are any tendency to drive long distances without taking a break, how other individuals may describe the user's driving style, etc. In certain embodiments, one or more first responses from the user to the one or more questions are received. For example, the user provides initial answers to each of the one or more questions.

In certain embodiments, the first discount value is determined for an insurance policy of a vehicle based at least in part upon the one or more first responses. In some embodiments, the one or more first responses are analyzed to determine the first discount value. In certain embodiments, the first discount value for the first insurance policy of the vehicle is presented. In some embodiments, one or more second responses from the user to the one or more questions are received. For example, the user may revise or change the initial answers to each of the one or more questions. In certain embodiments, the second discount value is determined for the insurance policy of the vehicle based at least in part upon the one or more second responses. In various embodiments, the one or more second responses are analyzed to determine the second discount value.

In some embodiments, the second discount value is applied to the insurance policy of the vehicle for a predetermined period of time. For example, the predetermined period of time may be one month in duration. As an example, a premium or cost associated with the first month of the insurance policy is reduced by an amount equal to the second discount value.

In certain embodiments, the driving data associated with one or more trips made by the vehicle during the predetermined period of time are collected. For example, the driving data may indicate how frequently the user drives, type of maneuvers that the user makes while driving, types of road that the user drives on, number of reported accidents/collisions, types of dangerous driving events, and/or types of safe driving events. In various embodiments, the driving data are collected from one or more sensors (e.g., accelerometers, gyroscopes, barometers, GPS sensors, etc.) associated with the vehicle.

In some embodiments, the driving behavior of the user is determined based at least in part upon analyzing the driving data collected during the predetermine period of time. In certain embodiments, the user is presented with whether the driving behavior of the user is indicative of the second discount value. For example, the user is presented with an increasing trend line if the driving behavior of the user correlates with the second discount value. As an example, the user is presented with a decreasing trend line if the driving behavior of the user does not correlate with the second discount value.

In certain embodiments, the driving data are analyzed to determine the third discount value for the insurance policy of the vehicle. In various embodiments, the third discount value is determined based at least in part upon on the driving behavior of the user during the predetermined period of time.

In some embodiments, after the predetermined period of time, the second discount value is replaced with the third discount value and the third discount value is applied to the insurance policy of the vehicle. For example, the third discount value is applied to the insurance policy of the vehicle for one or more subsequent months covered by the insurance policy.

In certain embodiments, a method for indicating user driving behavior in view of vehicle insurance discounts determined by one or more user responses to one or more questions includes presenting the one or more questions to a user; receiving one or more first responses from the user to the one or more questions; determining a first discount value for an insurance policy of a vehicle based at least in part upon the one or more first responses; presenting the first discount value for the insurance policy of the vehicle; receiving one or more second responses from the user to the one or more questions; determining a second discount value for the insurance policy of the vehicle based at least in part upon the one or more second responses; applying the second discount value to the insurance policy of the vehicle for a predetermined period of time; collecting driving data associated with one or more trips made by the vehicle during the predetermined period of time; determining a driving behavior of the user based at least in part upon analyzing the driving data collected during the predetermined period of time; presenting to the user whether the driving behavior of the user is indicative of the second discount value; analyzing the driving data to determine a third discount value for the insurance policy of the vehicle; and/or after the predetermined period of time, replacing the second discount value with the third discount value and applying the third discount value to the insurance policy of the vehicle.

In some embodiments, a computing device for indicating user driving behavior in view of vehicle insurance discounts determined by one or more user responses to one or more questions includes one or more processors and a memory that stores instructions for execution by the one or more processors. The instructions, when executed, cause the one or more processors to present the one or more questions to a user; receive one or more first responses from the user to the one or more questions; determine a first discount value for an insurance policy of a vehicle based at least in part upon the one or more first responses; present the first discount value for the insurance policy of the vehicle; receive one or more second responses from the user to the one or more questions; determine a second discount value for the insurance policy of the vehicle based at least in part upon the one or more second responses; apply the second discount value to the insurance policy of the vehicle for a predetermined period of time; collect driving data associated with one or more trips made by the vehicle during the predetermined period of time; determine a driving behavior of the user based at least in part upon analyzing the driving data collected during the predetermined period of time; present to the user whether the driving behavior of the user is indicative of the second discount value; analyze the driving data to determine a third discount value for the insurance policy of the vehicle; and/or after the predetermined period of time, replace the second discount value with the third discount value and apply the third discount value to the insurance policy of the vehicle.

In certain embodiments, a non-transitory computer-readable medium stores instructions for indicating user driving behavior in view of vehicle insurance discounts determined by one or more user responses to one or more questions. The instructions are executed by one or more processors of a computing device. The non-transitory computer-readable medium includes instructions to present the one or more questions to a user; receive one or more first responses from the user to the one or more questions; determine a first discount value for an insurance policy of a vehicle based at least in part upon the one or more first responses; present the first discount value for the insurance policy of the vehicle; receive one or more second responses from the user to the one or more questions; determine a second discount value for the insurance policy of the vehicle based at least in part upon the one or more second responses; apply the second discount value to the insurance policy of the vehicle for a predetermined period of time; collect driving data associated with one or more trips made by the vehicle during the predetermined period of time; determine a driving behavior of the user based at least in part upon analyzing the driving data collected during the predetermined period of time; present to the user whether the driving behavior of the user is indicative of the second discount value; analyze the driving data to determine a third discount value for the insurance policy of the vehicle; and/or after the predetermined period of time, replace the second discount value with the third discount value and apply the third discount value to the insurance policy of the vehicle.

According to some embodiments, a system and/or method for presenting vehicle insurance discounts determined by one or more user responses to one or more questions includes presenting questions to a user, receiving first responses from the user, determining a first discount value, presenting the first discount value, receiving second responses from the user, determining a second discount value, generating one or more first statistical data associated with the first responses, generating one or more second statistical data associated with the second responses, collecting driving data during a predetermined period of time, presenting a driving behavior determined during the predetermined period of time, and/or providing one or more feedbacks after the predetermined period of time.

In certain embodiments, one or more questions are presented to the user. In various embodiments, the one or more questions ask how often the user drives, how many miles are driven per week, if there are any tendency to drive at excessive speed, if there are any tendency to drive long distances without taking a break, how other individuals may describe the user's driving style, etc.

In some embodiments, one or more first responses from the user to the one or more questions are received. For example, the user provides initial answers to each of the one or more questions. In certain embodiments, the first discount value is determined for an insurance policy of a vehicle based at least in part upon the one or more first responses. In some embodiments, the one or more first responses are analyzed to determine the first discount value. In certain embodiments, the first discount value for the first insurance policy of the vehicle is presented. In some embodiments, one or more second responses from the user to the one or more questions are received. For example, the user may revise or change the initial answers to each of the one or more questions. In certain embodiments, the second discount value is determined for the insurance policy of the vehicle based at least in part upon the one or more second responses. In some embodiments, the one or more second responses are analyzed to determine the second discount value.

In certain embodiments, the one or more first statistical data associated with the one or more first responses to the one or more questions are generated. For example, the one or more first statistical data indicate how the one or more first responses by the user compare to one or more other responses to the one or more questions by one or more other users.

In some embodiments, the one or more second statistical data associated with the one or more second responses to the one or more questions are generated. For example, the one or more second statistical data indicate how the one or more second responses by the user compare to the one or more other responses to the one or more questions by the one or more other users.

In certain embodiments, the driving data associated with one or more trips made by a vehicle operated by the user during the predetermined period of time are collected. For example, the driving data may indicate how frequently the user drives, type of maneuvers that the user makes while driving, types of road that the user drives on, number of reported accidents/collisions, types of dangerous driving events, and/or types of safe driving events. In various embodiments, the driving data are collected from one or more sensors (e.g., accelerometers, gyroscopes, barometers, GPS sensors, etc.) associated with the vehicle.

In some embodiments, the user is presented with whether the driving behavior of the user during the predetermined period of time is indicative of the second discount value. For example, the user is presented with a trend line that increases if the driving behavior correlates with the second discount value and decreases if the driving behavior does not correlate with the second discount value.

In certain embodiments, after the predetermined period of time, the user is presented with the one or more feedbacks based at least in part upon the driving data collected during the predetermined period of time. For example, the one or more feedbacks include various driving tips that can help to improve the user's driving behavior.

In some embodiments, a method for presenting vehicle insurance discounts determined by one or more user responses to one or more questions includes presenting the one or more questions to a user; receiving one or more first responses from the user to the one or more questions; determining a first discount value for an insurance policy of a vehicle based at least in part upon the one or more first responses; presenting the first discount value for the insurance policy of the vehicle; receiving one or more second responses from the user to the one or more questions; determining a second discount value for the insurance policy of the vehicle based at least in part upon the one or more second responses; generating one or more first statistical data associated with the one or more first responses to the one or more questions that indicate how the one or more first responses by the user compare to one or more other responses to the one or more questions by one or more other users; generating one or more second statistical data associated with the one or more second responses to the one or more questions that indicate how the one or more second responses by the user compare to the one or more other responses to the one or more questions by the one or more other users; collecting driving data associated with one or more trips made by a vehicle operated by the user during a predetermined period of time; presenting to the user whether a driving behavior of the user during the predetermined period of time is indicative of the second discount value; and/or after the predetermined period of time, providing one or more feedbacks to the user based at least in part upon the driving data collected during the predetermined period of time.

In certain embodiments, a computing device for presenting vehicle insurance discounts determined by one or more user responses to one or more questions includes one or more processors and a memory that stores instructions for execution by the one or more processors. The instructions, when executed, cause the one or more processors to present the one or more questions to a user; receive one or more first responses from the user to the one or more questions; determine a first discount value for an insurance policy of a vehicle based at least in part upon the one or more first responses; present the first discount value for the insurance policy of the vehicle; receive one or more second responses from the user to the one or more questions; determine a second discount value for the insurance policy of the vehicle based at least in part upon the one or more second responses; generate one or more first statistical data associated with the one or more first responses to the one or more questions that indicate how the one or more first responses by the user compare to one or more other responses to the one or more questions by one or more other users; generate one or more second statistical data associated with the one or more second responses to the one or more questions that indicate how the one or more second responses by the user compare to the one or more other responses to the one or more questions by the one or more other users; collect driving data associated with one or more trips made by a vehicle operated by the user during a predetermined period of time; present to the user whether a driving behavior of the user during the predetermined period of time is indicative of the second discount value; and/or after the predetermined period of time, provide one or more feedbacks to the user based at least in part upon the driving data collected during the predetermined period of time.

In some embodiments, a non-transitory computer-readable medium stores instructions for presenting vehicle insurance discounts determined by one or more user responses to one or more questions. The instructions are executed by one or more processors of a computing device. The non-transitory computer-readable medium includes instructions to present the one or more questions to a user; receive one or more first responses from the user to the one or more questions; determine a first discount value for an insurance policy of a vehicle based at least in part upon the one or more first responses; present the first discount value for the insurance policy of the vehicle; receive one or more second responses from the user to the one or more questions; determine a second discount value for the insurance policy of the vehicle based at least in part upon the one or more second responses; generate one or more first statistical data associated with the one or more first responses to the one or more questions that indicate how the one or more first responses by the user compare to one or more other responses to the one or more questions by one or more other users; generate one or more second statistical data associated with the one or more second responses to the one or more questions that indicate how the one or more second responses by the user compare to the one or more other responses to the one or more questions by the one or more other users; collect driving data associated with one or more trips made by a vehicle operated by the user during a predetermined period of time; present to the user whether a driving behavior of the user during the predetermined period of time is indicative of the second discount value; and/or after the predetermined period of time, provide one or more feedbacks to the user based at least in part upon the driving data collected during the predetermined period of time.

### VI. EXAMPLES OF MACHINE LEARNING ACCORDING TO CERTAIN EMBODIMENTS

According to some embodiments, a processor or a processing element may be trained using supervised machine learning and/or unsupervised machine learning, and the machine learning may employ an artificial neural network, which, for example, may be a convolutional neural network, a recurrent neural network, a deep learning neural network, a reinforcement learning module or program, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

According to certain embodiments, machine learning programs may be trained by inputting sample data sets or certain data into the programs, such as images, object statistics and information, historical estimates, and/or actual repair costs. The machine learning programs may utilize deep learning algorithms that may be primarily focused on pattern recognition and may be trained after processing multiple examples. The machine learning programs may include Bayesian Program Learning (BPL), voice recognition and synthesis, image or object recognition, optical character recognition, and/or natural language processing. The machine learning programs may also include natural language processing, semantic analysis, automatic reasoning, and/or other types of machine learning.

According to some embodiments, supervised machine learning techniques and/or unsupervised machine learning techniques may be used. In supervised machine learning, a processing element may be provided with example inputs and their associated outputs and may seek to discover a general rule that maps inputs to outputs, so that when subsequent novel inputs are provided the processing element may, based upon the discovered rule, accurately predict the correct output. In unsupervised machine learning, the processing element may need to find its own structure in unlabeled example inputs.

### VII. ADDITIONAL CONSIDERATIONS ACCORDING TO CERTAIN EMBODIMENTS

For example, some or all components of various embodiments of the present disclosure each are, individually and/or in combination with at least another component, implemented using one or more software components, one or more hardware components, and/or one or more combinations of software and hardware components. As an example, some or all components of various embodiments of the present disclosure each are, individually and/or in combination with at least another component, implemented in one or more circuits, such as one or more analog circuits and/or one or more digital circuits. For example, while the embodiments described above refer to particular features, the scope of the present disclosure also includes embodiments having different combinations of features and embodiments that do not include all of the described features. As an example, various embodiments and/or examples of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Certain implementations may also be used, however, such as firmware or even appropriately designed hardware configured to perform the methods and systems described herein.

The systems' and methods' data (e.g., associations, mappings, data input, data output, intermediate data results, final data results) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the present disclosure is not to be limited by the specific illustrated embodiments.

1. A method for providing vehicle insurance discounts, the method comprising:
presenting, by a computing device, one or more questions to a user;
receiving, from the user by the computing device, one or more first responses to the one or more questions;
generating, by the computing device, one or more first statistical data associated with the one or more first responses to the one or more questions, the one or more first statistical data indicating how the one or more first responses by the user compare to one or more other responses to the one or more questions by one or more other users;
determining, by the computing device, a first discount value for an insurance policy of a vehicle based at least in part upon the one or more first responses;
presenting, to the user by the computing device, the first statistical data and the first discount value for the insurance policy of the vehicle;
receiving, from the user by the computing device, one or more second responses to the one or more questions;
determining, by the computing device, a second discount value for the insurance policy of the vehicle based at least in part upon the one or more second responses;
determining, by the computing device, an initial discount value based at least in part upon the first discount value and the second discount value, wherein:
if the first discount value and the second discount value are not equal, the initial discount value is equal to greater of the first discount value and the second discount value; and
if the first discount value and the second discount value are equal, the initial discount value is equal to the first discount value;
applying, automatically by the computing device, the initial discount value to the insurance policy of the vehicle for a predetermined period of time;
collecting, by the computing device, driving data associated with one or more trips made by the vehicle during the predetermined period of time;
processing, by the computing device, the driving data to determine a third discount value for the insurance policy of the vehicle based upon the driving data; and
after the predetermined period of time,
replacing, automatically by the computing device, the initial discount value with the third discount value; and
applying, automatically by the computing device, the third discount value to the insurance policy of the vehicle.

2. The method of claim 1, wherein the third discount value is different from the initial discount value.

3. The method of claim 1, wherein the third discount value is the same as the initial discount value.

4. (canceled)

5. The method of claim 1, further comprising:
generating, by the computing device, one or more second statistical data associated with the one or more second responses to the one or more questions, the one or more second statistical data indicating how the one or more second responses by the user compare to the one or more other responses to the one or more questions by the one or more other users; and
presenting the second statistical data to the user.

6. The method of claim 1, further comprising:
analyzing, by the computing device, a part of the driving data collected during a part of the predetermined period of time;
determining, by the computing device, a driving behavior of the user during the part of the predetermined period of time based at least in part upon the part of the driving data;
determining, by the computing device, a fourth discount value based at least in part upon the driving behavior of the user;
comparing, by the computing device, the fourth discount value with the initial discount value; and
presenting, to the user by the computing device, whether the driving behavior of the user is indicative of the initial discount value.

7. The method of claim 1, further comprising:
after the predetermined period of time, providing, by the computing device, one or more feedbacks to the user based at least in part upon the driving data collected during the predetermined period of time.

8. A computing device for providing vehicle insurance discounts, the computing device comprising:
one or more processors; and
a memory storing instructions that, when executed by the one or more processors, cause the one or more processors to:
present one or more questions to a user;
receive, from the user, one or more first responses to the one or more questions;
generate one or more first statistical data associated with the one or more first responses to the one or more questions, the one or more first statistical data indicating how the one or more first responses by the user compare to one or more other responses to the one or more questions by one or more other users;
determine a first discount value for an insurance policy of a vehicle based at least in part upon the one or more first responses;
present, to the user, the first statistical data and the first discount value for the insurance policy of the vehicle;
receive, from the user, one or more second responses to the one or more questions;
determine a second discount value for the insurance policy of the vehicle based at least in part upon the one or more second responses;
determine an initial discount value based at least in part upon the first discount value and the second discount value, wherein:
if the first discount value and the second discount value are not equal, the initial discount value is equal to greater of the first discount value and the second discount value; and
if the first discount value and the second discount value are equal, the initial discount value is equal to the first discount value;
apply automatically the initial discount value to the insurance policy of the vehicle for a predetermined period of time;
collect driving data associated with one or more trips made by the vehicle during the predetermined period of time;
process the driving data to determine a third discount value for the insurance policy of the vehicle based upon the driving data; and
after the predetermined period of time,
replace automatically the initial discount value with the third discount value; and
apply automatically the third discount value to the insurance policy of the vehicle.

9. The computing device of claim 8, wherein the third discount value is different from the initial discount value.

10. The computing device of claim 8, wherein the third discount value is the same as the initial discount value.

11. (canceled)

12. The computing device of claim 8, wherein the instructions, when executed by the one or more processors, further cause the one or more processors to:
generate one or more second statistical data associated with the one or more second responses to the one or more questions, the one or more second statistical data indicating how the one or more second responses by the user compare to the one or more other responses to the one or more questions by the one or more other users; and
present the second statistical data to the user.

13. The computing device of claim 8, wherein the instructions, when executed by the one or more processors, further cause the one or more processors to:
analyze a part of the driving data collected during a part of the predetermined period of time;
determine a driving behavior of the user during the part of the predetermined period of time based at least in part upon the part of the driving data;
determine a fourth discount value based at least in part upon the driving behavior of the user;
compare the fourth discount value with the initial discount value; and
present, to the user, whether the driving behavior of the user is indicative of the initial discount value.

14. The computing device of claim 8, wherein the instructions, when executed by the one or more processors, further cause the one or more processors to:
after the predetermined period of time, provide one or more feedbacks to the user based at least in part upon the driving data collected during the predetermined period of time.

15. A non-transitory computer-readable medium stores instructions for providing vehicle insurance discounts, the instructions when executed by one or more processors of a computing device, cause the computing device to:
present one or more questions to a user;
receive, from the user, one or more first responses to the one or more questions;
generate one or more first statistical data associated with the one or more first responses to the one or more questions, the one or more first statistical data indicating how the one or more first responses by the user compare to one or more other responses to the one or more questions by one or more other users;
determine a first discount value for an insurance policy of a vehicle based at least in part upon the one or more first responses;
present, to the user, the first statistical data and the first discount value for the insurance policy of the vehicle;
receive, from the user, one or more second responses to the one or more questions;
determine a second discount value for the insurance policy of the vehicle based at least in part upon the one or more second responses;
determine an initial discount value based at least in part upon the first discount value and the second discount value, wherein:
if the first discount value and the second discount value are not equal, the initial discount value is equal to greater of the first discount value and the second discount value; and
if the first discount value and the second discount value are equal, the initial discount value is equal to the first discount value;
apply automatically the initial discount value to the insurance policy of the vehicle for a predetermined period of time;
collect driving data associated with one or more trips made by the vehicle during the predetermined period of time;
process the driving data to determine a third discount value for the insurance policy of the vehicle based upon the driving data; and
after the predetermined period of time,
replace automatically the initial discount value with the third discount value; and
apply automatically the third discount value to the insurance policy of the vehicle.

16. The non-transitory computer-readable medium of claim 15, wherein the third discount value is different from the initial discount value.

17. The non-transitory computer-readable medium of claim 15, wherein the third discount value is the same as the initial discount value.

18. The non-transitory computer-readable medium of claim 15, wherein the instructions, when executed by the one or more processors, further cause the computing device to:
generate one or more second statistical data associated with the one or more second responses to the one or more questions, the one or more second statistical data indicating how the one or more second responses by the user compare to the one or more other responses to the one or more questions by the one or more other users; and
present the second statistical data to the user.

19. The non-transitory computer-readable medium of claim 15, wherein the instructions, when executed by the one or more processors, further cause the computing device to:
analyze a part of the driving data collected during a part of the predetermined period of time;
determine a driving behavior of the user during the part of the predetermined period of time based at least in part upon the part of the driving data;
determine a fourth discount value based at least in part upon the driving behavior of the user;
compare the fourth discount value with the initial discount value; and
present, to the user, whether the driving behavior of the user is indicative of the initial discount value.

20. The non-transitory computer-readable medium of claim 15, wherein the instructions, when executed by the one or more processors, further cause the computing device to:
after the predetermined period of time, provide one or more feedbacks to the user based at least in part upon the driving data collected during the predetermined period of time.
